(19) United States
(12) Patent Application Publication
(10) Pub. No.: US 2009/0327928 A1
(43) Pub. Date: Dec. 31, 2009

(54) Method and System Facilitating Two-Way Interactive Communication and Relationship Management

(76) Inventors: Anastasia Dedis, Lutz, FL (US); Panos E. Kontses, Lutz, FL (US)

Correspondence Address: WHITE-WELKER & WELKER, LLC, P.O. BOX 199, CLEAR SPRING, MD, 21722-0199, US

(21) Appl. No.: 12/398,257

(22) Filed: Mar. 5, 2009

Related U.S. Application Data
(60) Provisional application No. 61/033,845, filed on Mar. 5, 2008.

(51) Int. Cl. G06F 3/048

(52) U.S. Cl. 715/763

(57) ABSTRACT

A tool, method, and system that facilitates two-way interactive brokered commercial communication network between consumers and commercial entities. A Leaf holds all commercial relationship information and any relevant to the specific Seller information. A Relationship Tree is an organizer as well as a communications tool. A Tree can be turned to lists by clicking one of the controls. Each Branch can be isolated and enlarged by clicking on it, for better viewing. The leafs are placed on the tree by the owner who can drag and drop in the desired place. Each new leaf awaits under the tree to be hung in the desired place by the tree owner and generate a relationship code. Different Trees can be used for different purposes each escorted by relevant tools and gadgets.

### CROSS REFERENCE TO RELATED APPLICATIONS

This application claims priority from U.S. Provisional Patent Application Ser. No. 61/033,845, entitled “Method and System Facilitating Two-Way Interactive Communication and Relationship Management”, filed on 5 Mar. 2008. The benefit under 35 USC § 119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to communication systems. More specifically, the present invention relates to a Method and System that facilitates a relationship management system.

### BACKGROUND OF THE INVENTION

In the virtual world, a Consumer on the web goes to a website and decides to register. To do so the user/she is asked to submit his/her e-mail. By doing so this person has in effect ‘opted-in’ an e-mailing list. The web site from there on will be able to send him/her messages. Some web sites send the first message asking verification so in effect requesting a ‘double opt-in’ before they place the e-mail in their permanent Mailing List. From here on this web site can send commercial messages to this e-mail as often and whenever it wishes until the Consumer ‘points-out’. A process leaving much to be desired on both sides. First the channel of communication is not secure so any Unsolicited Seller who obtains the e-mail address of the Consumer can ‘spam’ this e-mail address by sending unsolicited commercial messages and second some Sellers abuse the privilege and send far too many e-mails.

Then from the Consumer's point of view the problems are many and too well known: Multitude of e-mails bombarding their inbox, waste of time and frustration when they are trying to do their work and are constantly interrupted, and for those who use very good spam/junk filters different problems arise. Either many of the solicited messages somehow fall victim to the filters and are never received or end up not landing in the inbox or the commercial messages are received in the middle of working or doing something else, so they are opened, but since there was no time to read them, they are saved for later and are forgotten. In effect most solicited commercial messages never make it to the inbox and the ones that do, are in effect never read as they most likely arrived at the wrong moment. On top of all this, the ones that were read, but where not acted upon immediately, are hard to find when the Consumer is looking for them later.

From the Seller's or Marketer's point of view there are different problems: It is free but then again they get what they pay for. It is free for everybody to send an e-mail so it is not surprising that everyone does. It seems nice to be able to market without any cost other than the cost of acquiring the e-mail, but when a Seller has a huge list and they ‘hit’ it with a marketing message and results are bad what do they do? Good Luck knowing what to do. Have the messages arrived? The Seller doesn't know. Where they caught by filters? Could it be they did not like the offering and that's why they are not responding? Could it be that my list is getting old and most of these e-mails are abandoned? Endless questions with no answers. The Seller has no sure way of knowing what went wrong and how to react to fix it. It is pitiful how it works when you think of the cost of collecting and maintaining this list and how fragile the relationships are and how fast they can be ‘opted-out’ of as a result of a couple of wrong actions. There must be a better way!

In the physical world, a Consumer visits a place of business and decides to register for their mailing list. The user/she is interested to receive coupons. To do so the user/she is asked to submit his/her e-mail and/or home address. By doing so this person has in effect either ‘opted-in’ an e-mailing list or ‘opted-in’ a mailing list. We have reviewed the workings of the e-mailing list so let's take a look at how the mailing list works. The Seller from here on will be able to send the Consumer commercial messages by mail. Some Sellers will let Consumers decide what type of commercial messages they want to receive, but that in no way is binding to the Seller. They can still send Consumers anything they want, if they so choose, as often as they want until the Consumer ‘points-out’ which is often difficult, time consuming and can prove to be a hassle.

Let's examine the process from both sides. First, the channel of communication in this case becomes the Consumer's mailbox. The solicited commercial message will arrive among the multitude of junk mail and the Consumer's bills. Can't be too thrilled about that! Second, any Seller who buys a list of addresses can do the same without asking for the Consumer's permission.

From the Consumer's point of view the problems are many and too well known: There isn't a single American who does not dread getting his/her mail every evening. Junk mail bombarding their mailbox, wasting their time, frustrating them when all they wanted to do was find a bill that had to get paid and get to spend some time with their family and rest after a long day's work. Some Consumers join ‘prevent junk mail services’ with little or no results. Some are afraid to do even that for fear of not getting the ones they want to get. Most just end up doing what we all do: Open the mailbox every evening, carry the envelopes in, sort ‘junk-looking’ envelopes out, put them in the trash, and recycle the paper to prevent some of the waste. On the weekends some find a minute to go through the ‘doubtful’ ones, the ones they were not sure that they were junk. They open them, realize in an instant that it was in effect junk, and put them in the trash frustrated with all this. Some solicited commercial mail fell victim to the process and got thrown out with the junk, but who has the time to waste? Some valuable coupons have been gained from the process and a new problem arises: where is one to keep them so they can easily be found when they need to be used? From the Seller or Marketer's point of view there are different problems: The cost is tremendous and how do you design a mailer that will not get thrown away? Results are negligible, if any at all. But why then keep doing it? Because the competitors do, and it just doesn't feel right to be left out of the process, and also because hope dies last. What else can a small local store do other than get an address list and send something out?

Several systems known in the prior art have attempted to solve these communication problems, but all have failed or been unsuccessful in the market place due to their complex features or complete blocking of all communications, and that which is solicited by a user but is nearly identical to that of an unsolicited communication. The present invention creates a consumer controlled brokered network pathway that provides means for two-way communication between a consumer and commercial entity where a consumer welcomes both solicited and unsolicited commercial communications in the brokered network communications channel. The present invention is not a spam filter, which has been proven unsuccessful. Instead of trying to filter communications, the present invention creates a consumer controlled “commercial box” that provides a means for delivery of all (solicited and unsolicited) commercial messages. The present invention replaces the consumer's inbox and mailbox and instead provides an alternative means of communication by creating a consumer-initiated “box” exclusively dedicated to commercial messages. It is a new brokered communications channel especially designed so ALL commercial messages (solicited and unsolicited) can be received, stored and organized by the consumer within this two-way communication's channel with feedback and rewards.

Additionally, current systems taught by the prior art fail to isolate commercial messages from other communications and fail to recognize or permit requested, allowable, and permissible or other commercial communications to users and provide users with incentive to view, read, respond, or interact with the exclusive commercial communication. More importantly current systems taught by the prior art fail to see that if there is no ‘mutually satisfying’ way for a business to directly market to a consumer then the only thing left for businesses to do is to keep trying to outsmart spam/junk filters in an attempt to reach consumers. The current invention provides just that: a mutually beneficial, consumer-initiated channel where the consumer invites all commercial communications directed to him/her; and where the consumer can through the organizational tools provided within the channel save time and frustration and never miss out on something of interest to him/her. The consumer when opening this commercial communications channel, willingly offers relevant commercial information about him/her self to help seller's target the consumer more effectively (such info as likes, dislikes, demographics, etc.). The consumer also willingly provides feedback in order to receive rewards from the sellers.

For example, U.S. Pat. No. 6,052,709 teaches a system and method and system for controlling delivery of unsolicited electronic mail messages, one or more spam probe e-mail addresses are created and planted at various sites on the communications network in order to insure their inclusion on large-scale electronic junk mail (“spam”) mailing lists. The mailboxes corresponding to the spam probe e-mail addresses are monitored for incoming mail by a spam control center. Upon receipt of incoming mail addressed to the spam probe addresses, the spam control center automatically analyzes the received spam e-mail to identify the source of the message, extracts the spam source data from the message, and generates an alert signal containing the spam source data. This alert signal is broadcast to all network servers and/or all user terminals within the communications network. A filtering system implemented at the servers and/or user terminals receives the alert signal, updates stored filtering data using the spam source data retrieved.

U.S. Pat. No. 6,772,196 teaches a system that filters-out undesirable email messages sent to a user email address. The system includes a data store providing updateable storage of signature records that correspond to a subset of undesirable email messages that may be sent to the predetermined email address. An email filter processor is coupled to the store of signature records and operates against the email messages received at the predetermined email address to identify and filter-out email messages corresponding to any of the signature records. An update system is provided to automatically receive a set of signature records, which are then used to update the plurality of signature records stored by the data store. The system can be implemented to include at least a portion of the email processor system within a client site email transport system, which receives the email messages addressed to the set of email addresses assigned or associated with the client site, including the predetermined email address.

U.S. Pat. No. 6,546,390 teaches a method and system for evaluating the relevancy of an incoming message to a plurality of users are disclosed. Similarity scores indicating similarities of the incoming message to features of a plurality of messages are generated. Relevancy scores are generated for the plurality of users indicating relevancies of the incoming message to the plurality of users based on the similarity scores and a plurality of user profiles including information descriptive of the plurality of users' preferences for the features.

U.S. Pat. No. 6,539,385 teaches a method and system are provided for use by an enterprise in which personal messages are processed differently than messages that are intended to constitute official enterprise correspondence (“enterprise messages”). An electronic communication including a message, a recipient identifier identifying at least one recipient of the message, and an status indicator indicating whether the message is a personal message or an enterprise message is received. The message is made available to the at least one recipient if the status indicator indicates that the message is a personal message. If the status indicator indicates that the message is an enterprise message, the message is stored in a searchable database and may also be made available to the at least one recipient.

U.S. Pat. No. 6,421,709 teaches a system and method of filtering junk e-mails. A user is provided with or compiles a list of e-mail addresses or character strings which a user would not wish to receive to produce a first filter. A second filter is provided including names and character strings which the user wishes to receive. Any e-mail addresses or strings contained in the first filter will be automatically eliminated from the user's system. Any e-mail addresses or strings contained in the second filter would be automatically sent to the user's “in box”. Any e-mail not provided in either of the filtered lists will be sent to a “waiting room” for user review. This user review results in the user rejecting any e-mail, the addresses as well as specific character strings included in this e-mail would be transmitted to a central location to be included in a master list.

U.S. Pat. No. 6,393,464 discloses a method for controlling the delivery of electronic mail. The method comprises the steps of: creating an allowed list of electronic addresses with which the user is permitted to freely exchange messages; categorizing as authorized each message that is sent to or received from an entity whose address is included on the list; categorizing as unauthorized each message that is sent to or received from an entity whose electronic address is not included in the list; transmitting authorized outgoing messages to their intended recipients; allowing the user to access the contents of authorized received messages. Also disclosed is a method for allowing an administrator to selectively approve messages that are sent to or received from entities whose electronic addresses do not appear on the allowed list.

US Patent Application Publication 20070038705 teaches decision trees populated with classifier models are leveraged to provide enhanced spam detection utilizing separate email classifiers for each feature of an email. This provides a higher probability of spam detection through tailoring of each classifier model to facilitate in more accurately determining spam on a feature-by-feature basis. Classifiers can be constructed based on linear models such as, for example, logistic-regression models and/or support vector machines (SVM) and the like. The classifiers can also be constructed based on decision trees. “Compound features” based on internal and/or external nodes of a decision tree can be utilized to provide linear classifier models as well. Smoothing of the spam detection results can be achieved by utilizing classifier models from other nodes within the decision tree if training data is sparse. This forms a base model for branches of a decision tree that may not have received substantial training data.

U.S. Pat. No. 6,842,739 teaches a system and method for operating a reward points accumulation and redemption program wherein a user earns reward points from a plurality of independent reward points issuing entities, with each tracking the user's earned reward points in a user reward point account stored on a rewards server (such as a frequent flyer account or a credit card loyalty account). A trading server accumulates some or all of the user's earned reward points from the reward servers and credits the accumulated points into a single reward exchange account associated with the user. The user may then select an item for purchase with the accumulated reward points. The item is provided to the user in exchange for a subset or all of the reward points.

U.S. Pat. No. 6,049,778 teaches a central controller stores a series of registrations, each of which corresponds to a purchaser of a product. The central controller calculates a measurement of product success, such as the number of products sold or the market share of the product. The central controller determines if the measurement is within a predetermined range. For example, the central controller may determine if the number of products sold exceeds a predetermined threshold. A selected set of registrations which are “early-adopter” registrations are selected. The set of registrations thereby defines a set of early-adopter purchasers. For example, the central controller may select a set of registrations having ordinal positions within a predetermined range of positions, such as the first hundred registrations. Thus, one hundred early-adopter purchasers are defined. If the measurement of product success is within the predetermined range, a reward, such as a refund.

U.S. Pat. No. 6,594,640 teaches a system and method for operating a reward points accumulation and redemption program wherein a user earns reward points from a plurality of independent reward points issuing entities, with each tracking the user's earned reward points in a user reward point account stored on a rewards server (such as a frequent flyer account or a credit card loyalty account). On selective request by the user, a trading server accumulates some or all of the user's earned reward points from the reward servers and credits the accumulated points into a single reward exchange account associated with the user. The user may then select an item for purchase with the accumulated reward points. The item is provided to the user in exchange for a subset or all of the reward points.

U.S. Pat. No. 6,874,023 teaches accessing web sites on which the user has an account and providing notification of changes at the site, and improved electronic mail management is provided, allowing all email to be collected and forwarded from a central site to other email addresses or allowing for the user to view the email at the central site. The user may assign individual email addresses to any number of uses, for example, an individual email address for use in communicating with a particular commercial web site.

U.S. Pat. No. 6,691,155 teaches an interactive, computer network based system presents consumers with multimedia brand information via a browser-based interface called the GraffitiWall. Consumers can use the GraffitiWall to modify and display a sponsor's brand information in any way desired. Consumer modifications are immediately communicated to the other member consumers and the advertiser/sponsor. Consumers can rate the GraffitiWall, or portions thereof, and email the GraffitiWall. An archive of GraffitiWalls is maintained by the system. Consumers participate in online focus groups, one-to-one interviews and discussions, as well as games and promotions pertaining to the brand. Interaction with consumers through focus groups, one-to-one interviews, discussions, games and promotions allows the hosting company to reinforce brand equities; speak directly to their target audience; test new and updated products and services; and encourage participation to a brand via purchases and signups by rewarding the participant.

Accordingly, there is a need for a system that is set up to receive, respond, and organize ALL commercial communication addressed to a user. Additionally, there is a need for a system that isolates commercial communication so that it can be managed efficiently; a system that gives sellers a mutually beneficial way to communicate with consumers so that they can abandon the bad practices of trying to outsmart junk/spam filters in their attempt to reach consumers. A system that understands and balances both the need of a consumer to receive solicited messages and keep them organized and the need of unsolicited sellers to market to consumers. This system does not believe in fighting the inevitable: the need of businesses to directly market to consumers (B to C). It believes in creating a mutually beneficial way for consumers to receive ALL commercial messages; isolate them from all other messages for better time management; organize them in a consumer-friendly way; and reward the willing consumers with rewards that cost much less to businesses than continuing to waste money and effort on trying to outsmart junk/spam filters and continue mailings that aggravate the consumer they are trying to reach.

### SUMMARY OF THE INVENTION

The present invention is Tool, Method, and System that facilitates Two-Way Interactive Commercial Communication with Feedback between Consumers and Sellers with Commercial Communication Loyalty Rewards and Commercial Partner Rings. From the Seller's point of view this Method and System is the evolution of List Building and Direct Marketing. From the Consumer's point of view this Tool is a Commercial Organizer and the evolution of subscribing to a Commercial Mailing List or e-Mailing List. From a joint seller/consumer point of view this is a consumer-initiated, mutually beneficial, rewarding, Tool, Method, and System for Commercial Networking between consumers and sellers.

A Leaf holds all commercial relationships, contact info, catalogues, links and any relevant to the specific Seller information. Each seller has his/her own leaf with a specific code assigned to it. A Tree is an organizer as well as a communications tool. Each consumer has his/her own tree with a specific code assigned to it. A Tree can be turned to lists by clicking one of the controls. Each Branch can be isolated and enlarged by clicking on it, for better viewing. A Leaf can be organized any way the tree owner desires. The leafs are placed on the tree by the owner who can drag and drop in the desired place. They can be moved at any time in the same manner.

A Tree 1 or a Branch 1a can be asked to drop all leafs if re-organization is desired. Each new leaf the owner of the tree acquires awaits under the tree to be hanged in the desired place by the tree owner. Each Branch can be named as the tree owner wishes. By default, they are numbered. Branches can be added to the tree by the consumer. Leaf holds all commercial relationships, contact info, catalogues, links and any relevant to the specific Seller information.

Within the present invention there are alternative embodiments that may utilize a loyalty program where consumers are rewarded not for shopping but for maintaining two-way commercial communication with merchants.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a Tree turned to a list;

FIGS. 2a, 2b, and 2c illustrate a Tree's organizer functionality;

FIGS. 3a, 3b, and 3c illustrate the tree tab of a Tree as an updater that holds messages for the three Trees;

FIG. 4 illustrates a Commercial Tree;

FIG. 5 illustrates a Social Tree;

FIG. 6 illustrates a Professional Tree;

FIG. 7 illustrates how a visitor sees a user's tree so that they cannot see branches or clusters;

FIGS. 8a-8c illustrates the views available to a Tree owner;

FIG. 9 is a simulated screen shot of the commercial uploader of the present invention;

FIG. 10 is a simulated screen shot of the new messages control panel of the present invention;

FIG. 11 is an illustration of the relationship and code generation for leaves hung by a consumer on their tree;

FIG. 12 is an illustration of the add/edit cluster; and

FIG. 13 is an illustration of the organized cluster example.

### SPECIFIC TERMS AND KEY DEFINITIONS

Commercial Communication is defined to mean any communication between two parties (a business and a person, a business and a business, or a person and a person) intended for commercial purposes i.e. to market, buy, sell, or follow-up a commercial transaction.

Consumer is defined to mean any person, business or entity having the potential, being interested to purchase, purchasing or having purchased goods or services, i.e. being a potential buyer or a buyer.

Seller or Marketer is defined to mean any person, business or entity interested in marketing or selling goods or services.

### DETAILED DESCRIPTION OF THE INVENTION

In the following detailed descriptions of the invention of exemplary embodiments. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a Tool, Method, and System that facilitates Two-Way Interactive Commercial Communication with Feedback between Consumers and Sellers with Commercial Communication Loyalty Rewards and Commercial Partner Rings. From the Seller's point of view this Method and System is the evolution of List Building and Direct Marketing. From the Consumer's point of view this Tool is a Commercial Organizer and the evolution of subscribing to a Commercial Mailing List or e-Mailing List. From a joint seller/consumer point of view this is a consumer-initiated, mutually beneficial, rewarding, Tool, Method, and System for Commercial Networking between consumers and sellers.

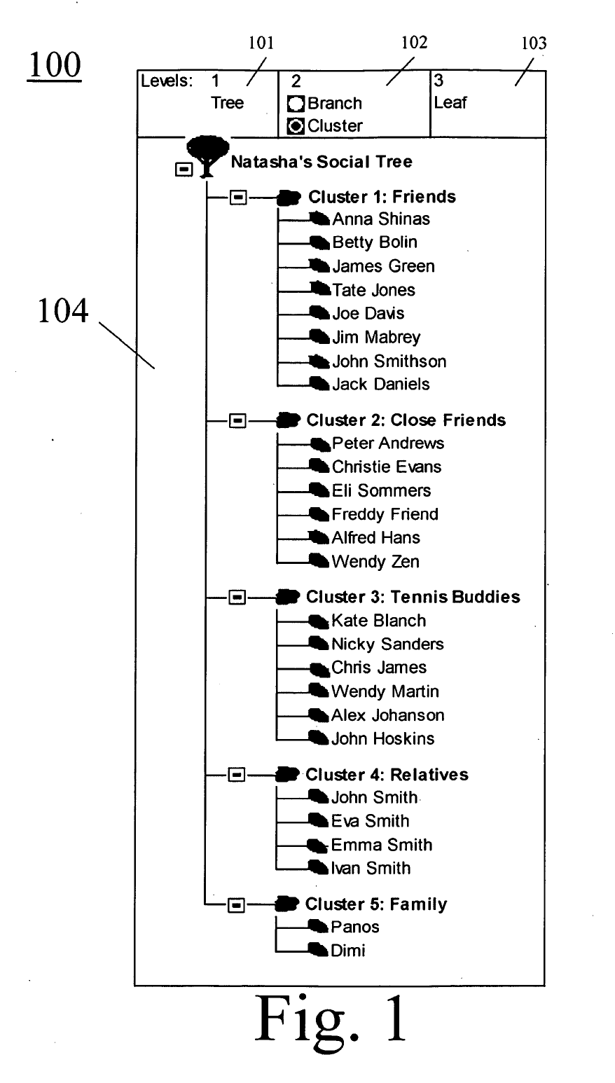

A tree has clusters or branches that can be used interchangeably. In most examples the present invention is demonstrating clusters since they are easier to show in a drawing. Trees 100 have three levels: Level 1: Tree (i.e. Social, Commercial, Professional, etc.) 101; Level 2: Branches or Clusters 102; and Level 3: Leafs (misspelled on purpose) 103. A tree can also be turned to a list 104 as illustrated in FIG. 1, if a user so desires.

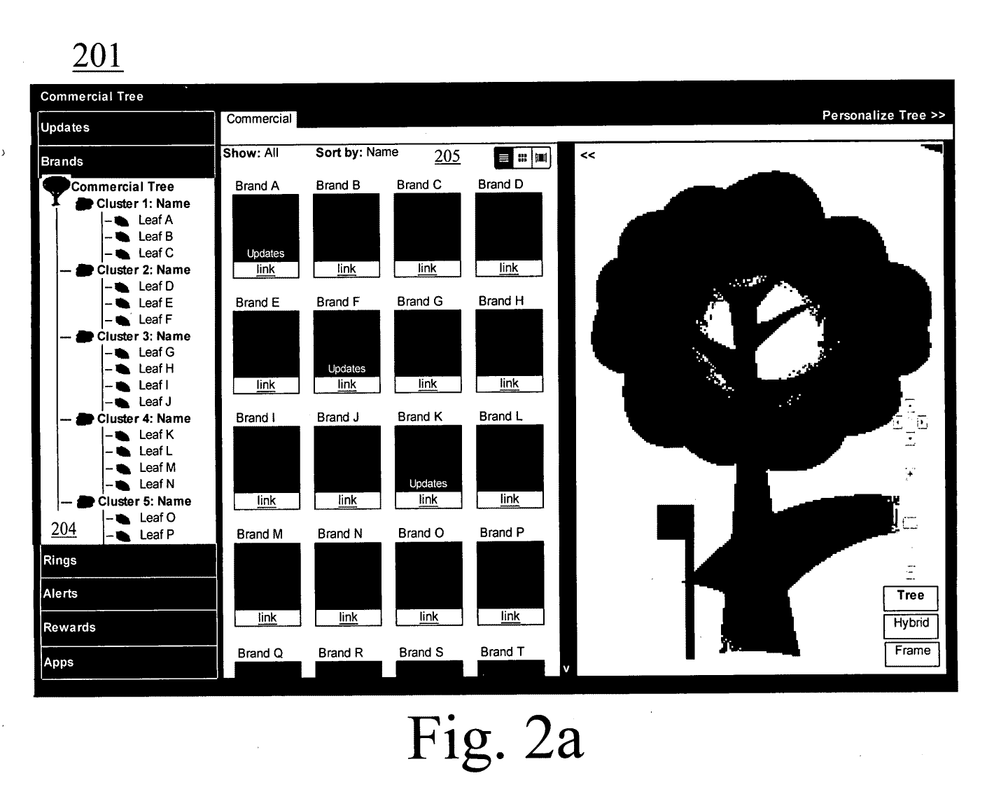

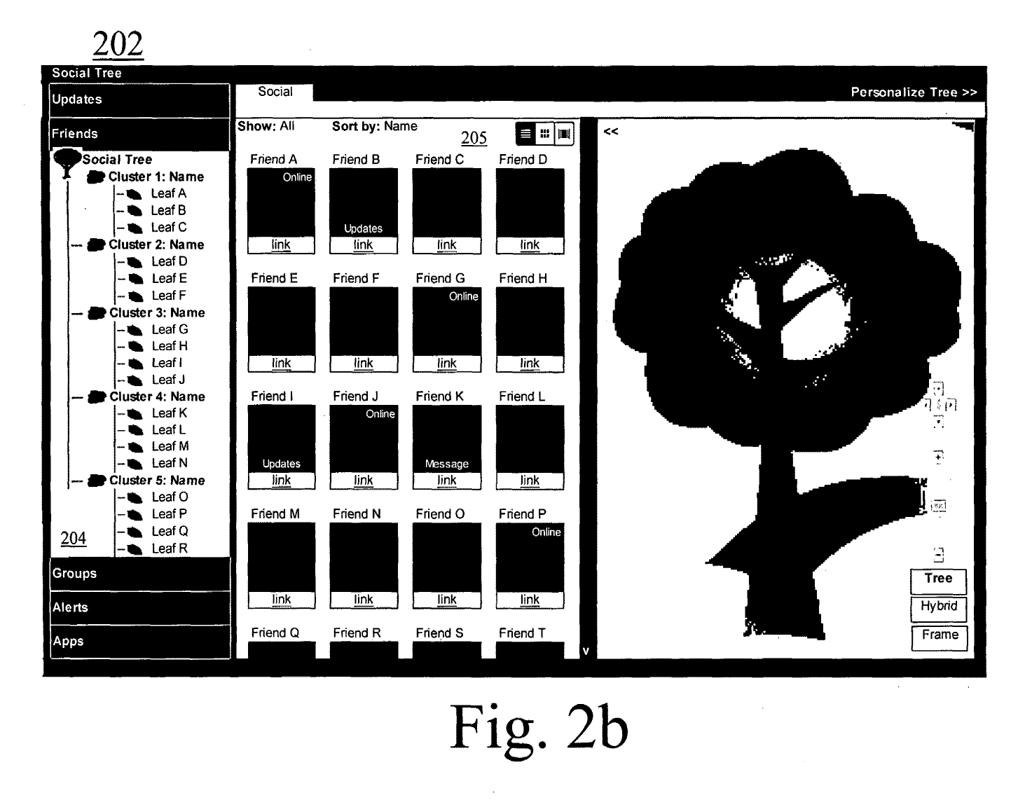

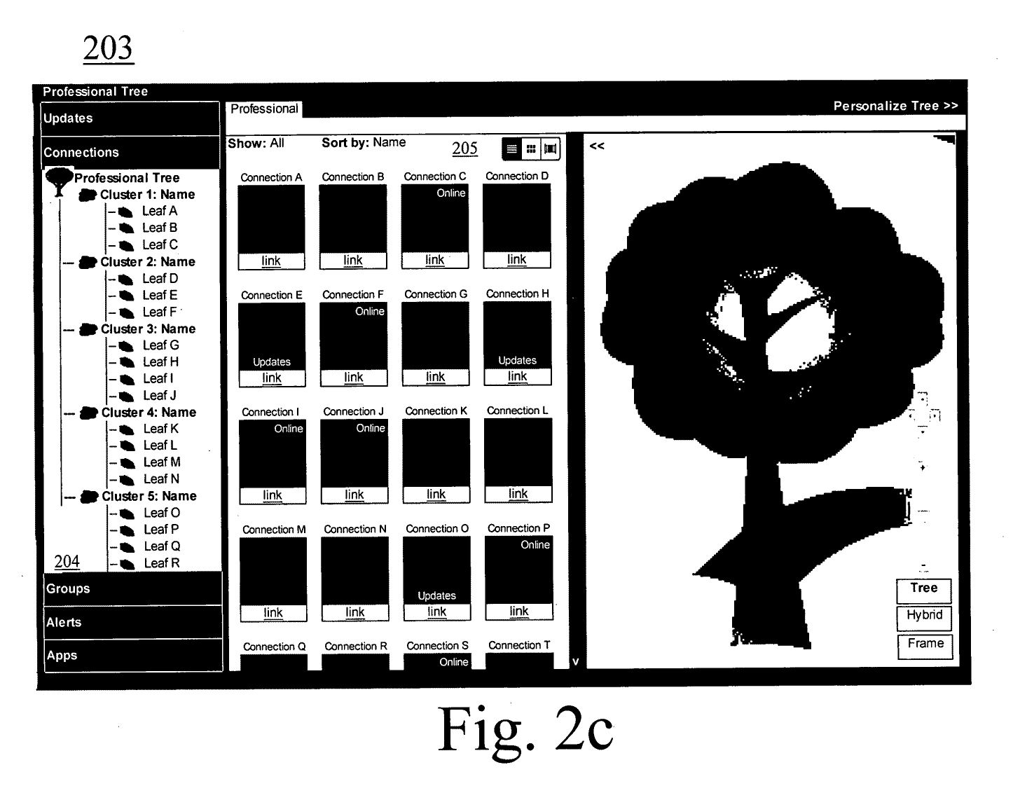

Now referring to FIGS. 2a, 2b, and 2c, the Tree illustrates its organizer functionality. The tree tab of the tree acts as an organizer and holds contacts for three trees: Commercial 201, Social 202 and Professional 203. The Tree list appears in one column 204 while contact details appear in another column 205. There are three alternate views available: the one shown, a more detailed and an enlarged photo one. A Tree can be enlarged to full screen and can be zoomed in and out and turned to Tree/Hybrid/Frame view.

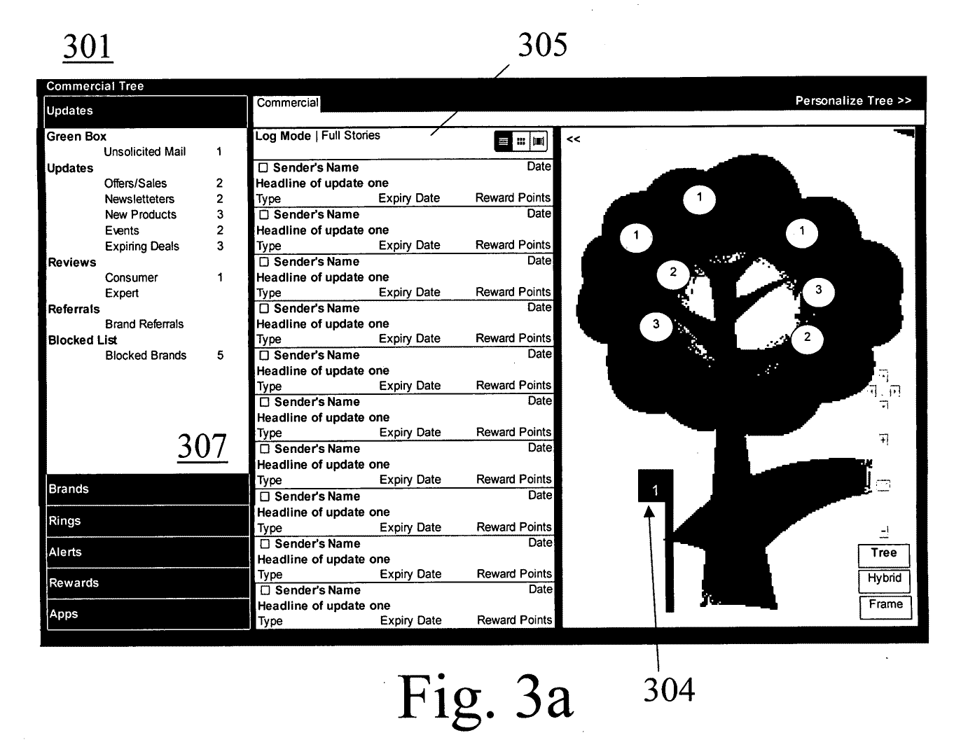

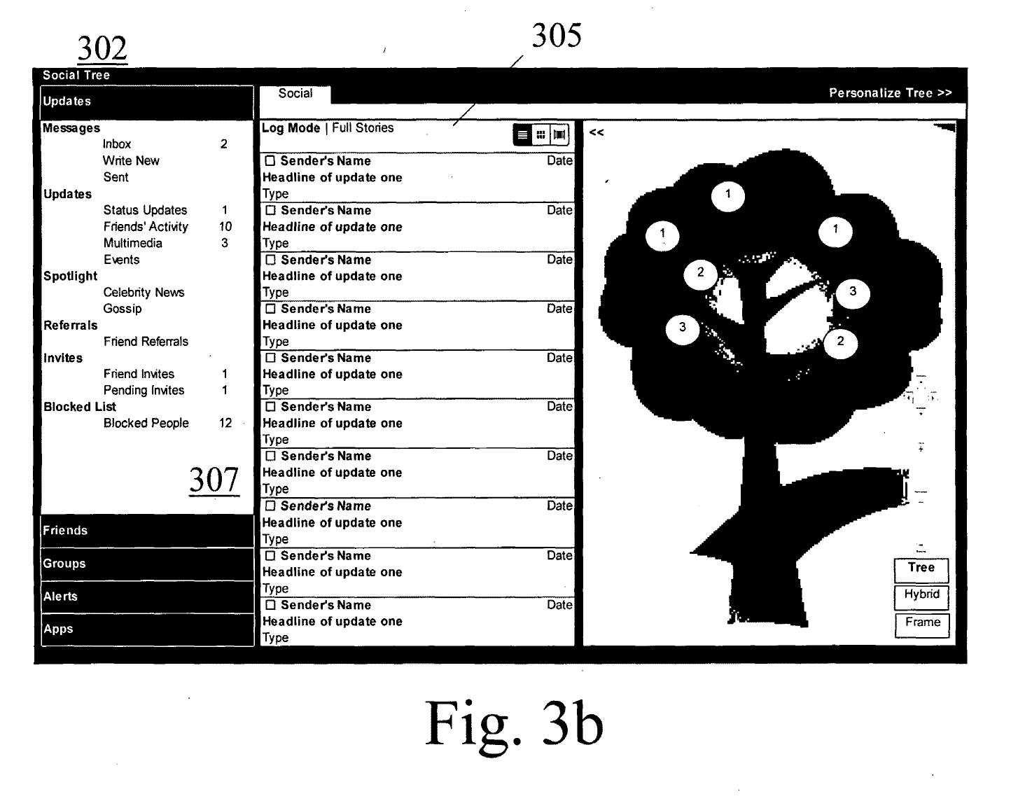

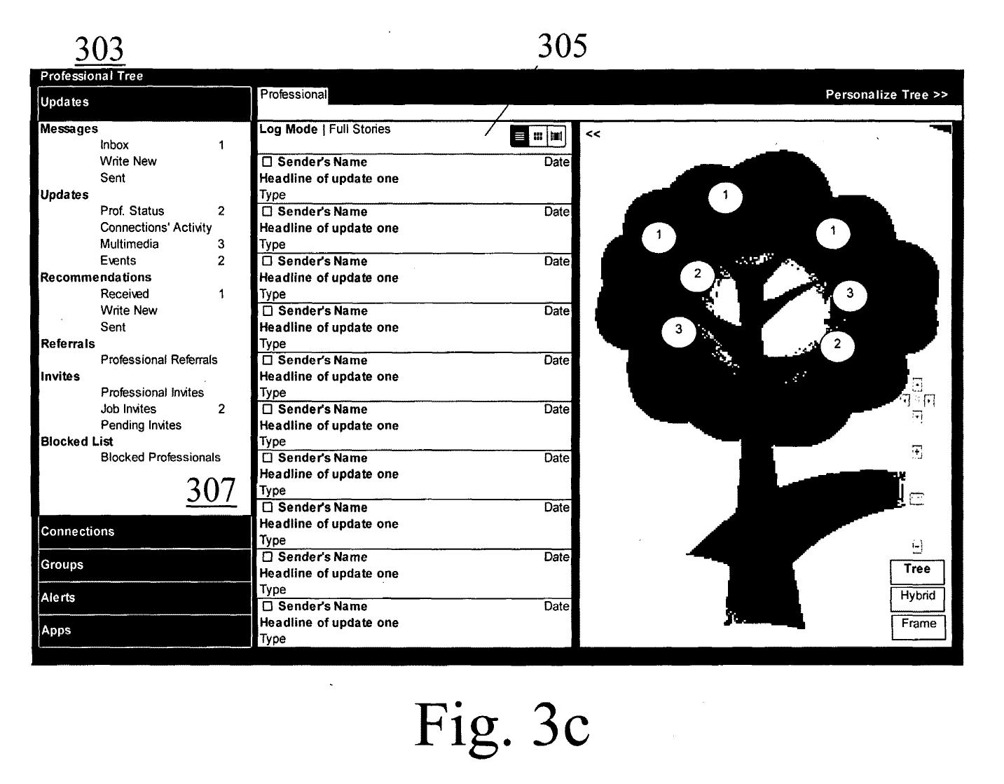

Now referring to FIGS. 3a, 3b, and 3c the tree tab of a Tree as an updater which holds messages for three Trees: Commercial 301, Social 302 and Professional Trees 303, is illustrated. When a user presses on a control 307 the equivalent leafs enlarge, by default messages 305 are listed in chronological order by date received and all leafs holding messages are enlarged. When a user hovers over a leaf 306, message details appear. A Box 304 can be clicked to view unsolicited messages for a Commercial Tree 301. Tree Controls 307 as needed for each tree appear on the first column. Tree Apps such as Tools & Gadgets appear in the same column when the Apps tab is clicked.

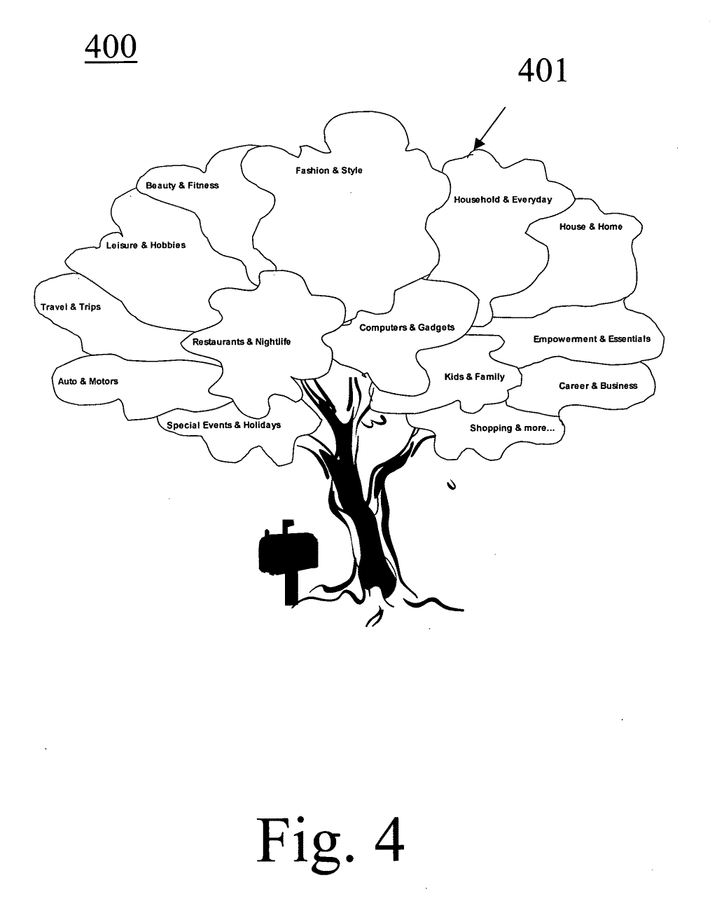

A Commercial Tree 400 as illustrated in FIG. 4 is made up of tagged clusters 401 only. The tree 400 is made up of 3 levels: Level 1: Tree; Level 2: Clusters or Branches; and Level 3: Leafs. A user chooses if the user/she wants to use Clusters or Branches.

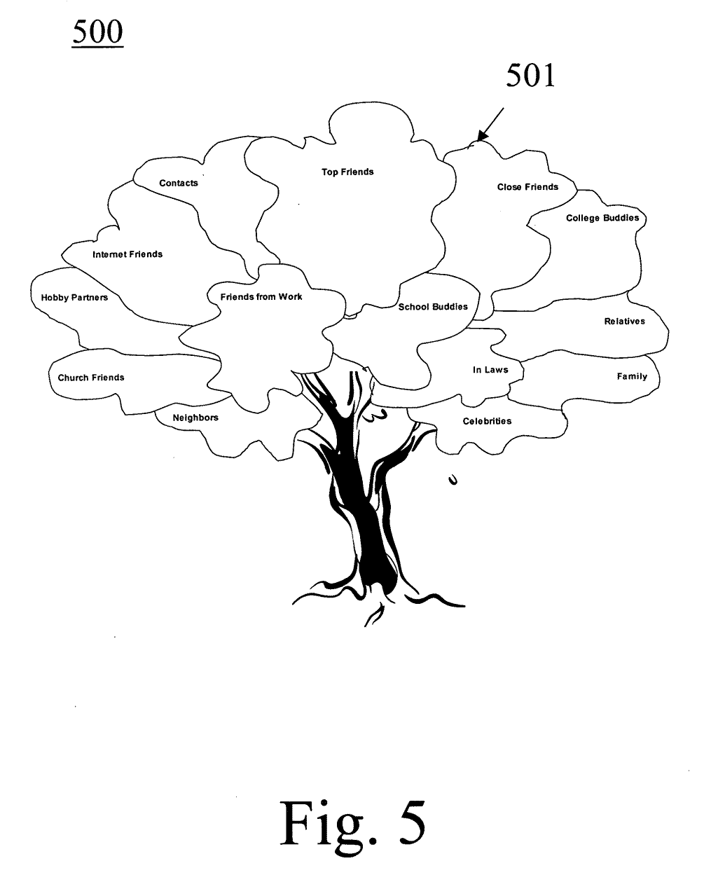

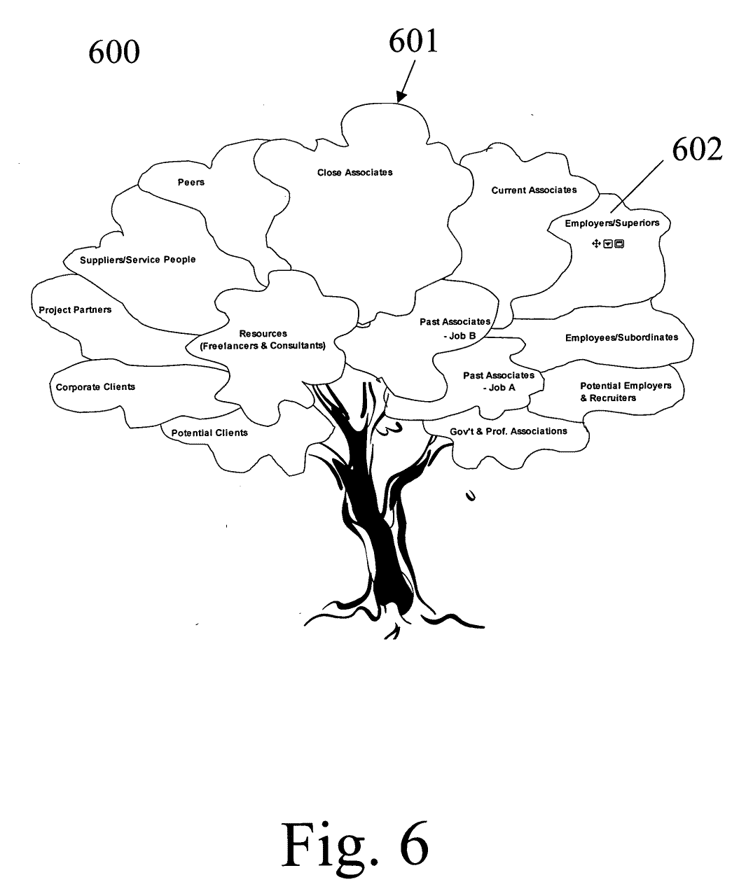

A Social Tree 500 as illustrated in FIG. 5 is made up of basic clusters 501 only while a Professional Tree 600 as illustrated in FIG. 6 is made up of basic 601 and tagged clusters 602. More trees can be designed based on all the principles described above, for any communication purpose, besides the ones shown as examples here.

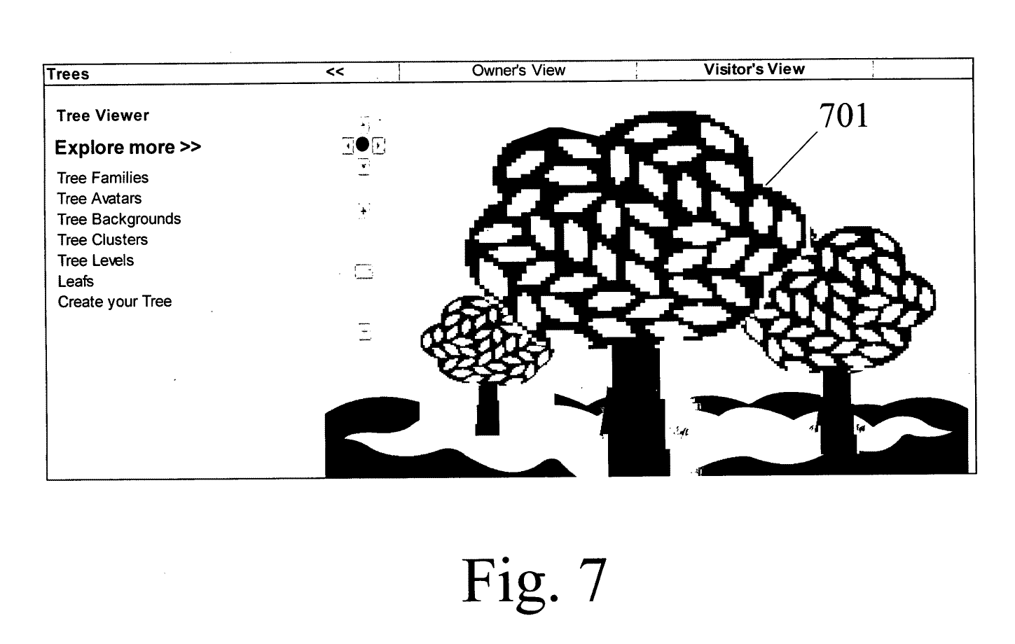

When a visitor sees a user's tree they cannot see branches or clusters. Leafs are randomly displayed inside the tree outline 701 as shown in FIG. 7. This is done in order to avoid any information being indirectly disclosed about the relationship between tree owner and each leaf owner, or leaf associations as viewed by the tree owner. For example, if on a friend's social tree, one could see clusters and discover that their leaf was on the same branch with this person's distant friends, it would lead one to believe that they were not highly regarded by this person.

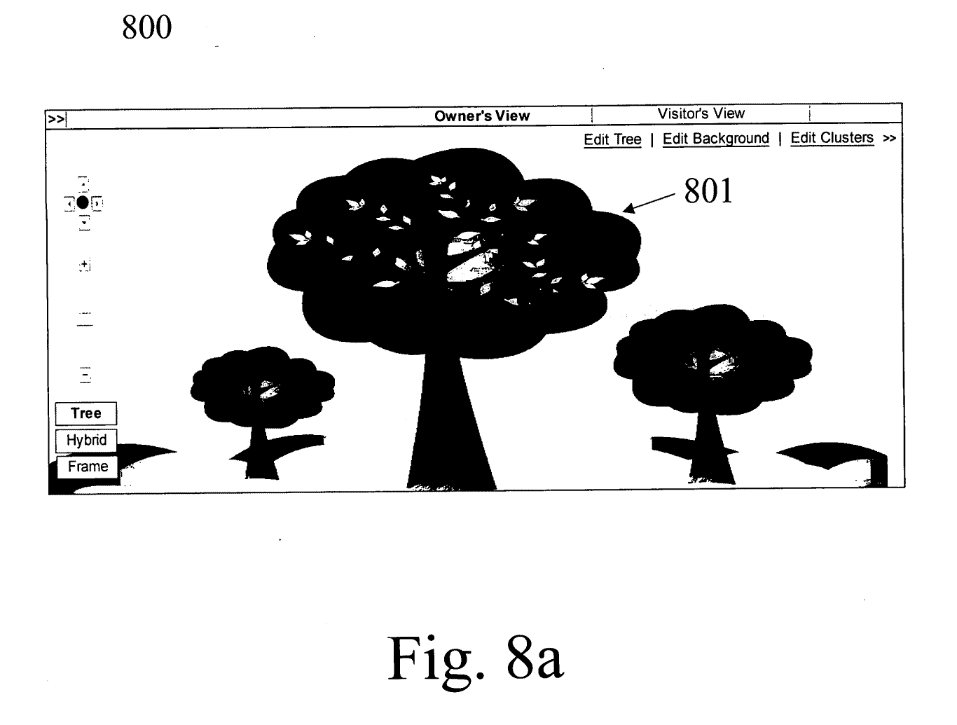

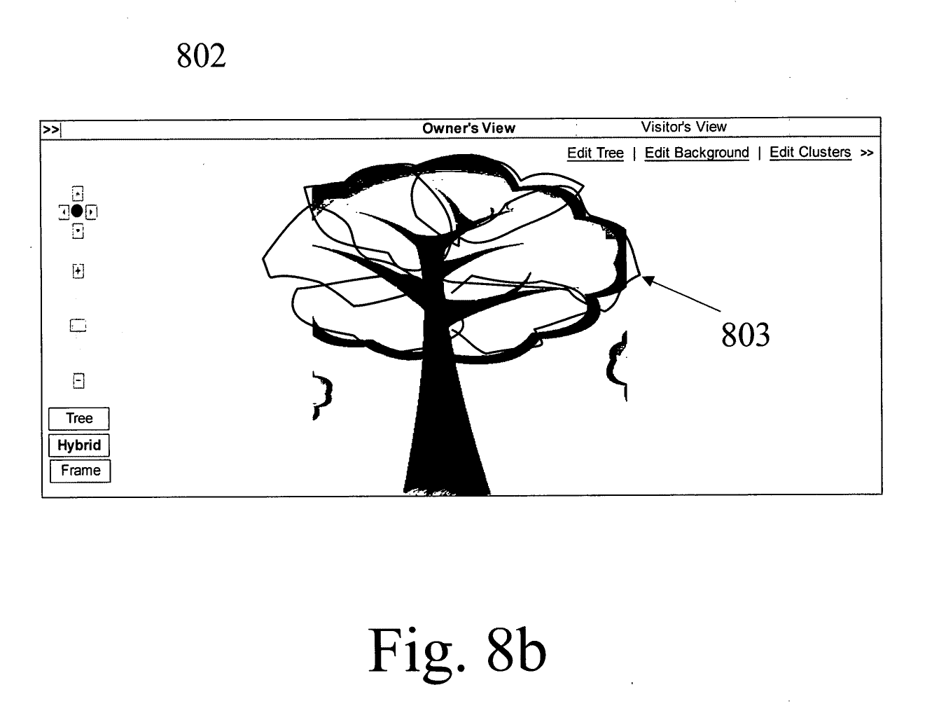

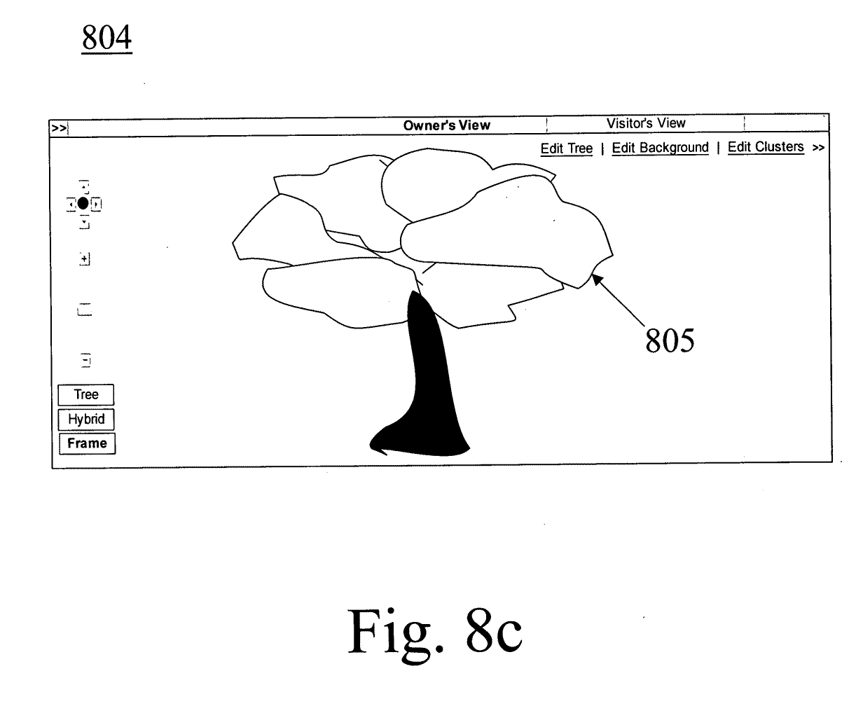

Now referring to FIGS. 8a-8c, a Tree Owner can explore their tree by zooming in and out. A minimum zoom level 800 shown in FIG. 8a displays whole tree 801. A Mid zoom level 802 shown in FIG. 8b displays branches or clusters 803. A maximum zoom level 804 shown in FIG. 8c displays leafs 805 and as owner hovers over details are shown. A Tree Owner can also switch tree views to: Tree, which is a full tree design as shown in FIG. 8a; Hybrid, which is a full tree and clustered designs shown simultaneously as shown in FIG. 8b; and Frame, which has a clustered design shown in FIG. 8c.

The popularity of tree levels can also be measured and displayed. Groupings include: Centurion: Any tree that has over 100 leafs, but less than 500; Supremus: Any tree that has over 500 leafs, but less than 1,000; Millennium: Any tree that has over 1,000 leafs; and Max: A Commercial tree that has all the leafs of the site's Sponsors. Max may be combined with the other groupings as well.

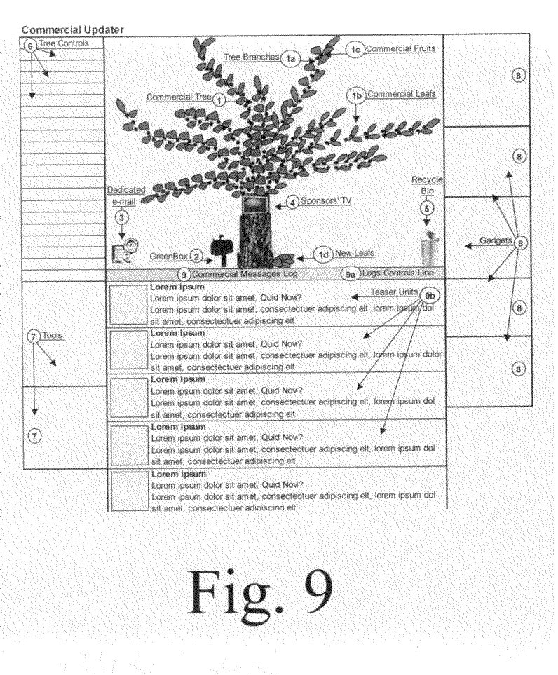

Now referring to FIG. 9, a Leaf 1b holds all commercial relationships, contact info, catalogues, links and any relevant to the specific Seller information. A Tree 1 is an organizer as well as a communications tool. A Tree 1 can be turned to lists by clicking one of the controls 6.

Each Branch or cluster 1a can be isolated and enlarged by clicking on it, for better viewing. A Leaf 1b can be organized any way the tree owner 1 desires. The leafs 1b are placed on the tree 1 by the owner who can drag and drop them in the desired place. The leafs 1b can be moved at any time in the same manner. A Tree 1 or a Branch 1a can be asked to drop all leafs if re-organization is desired.

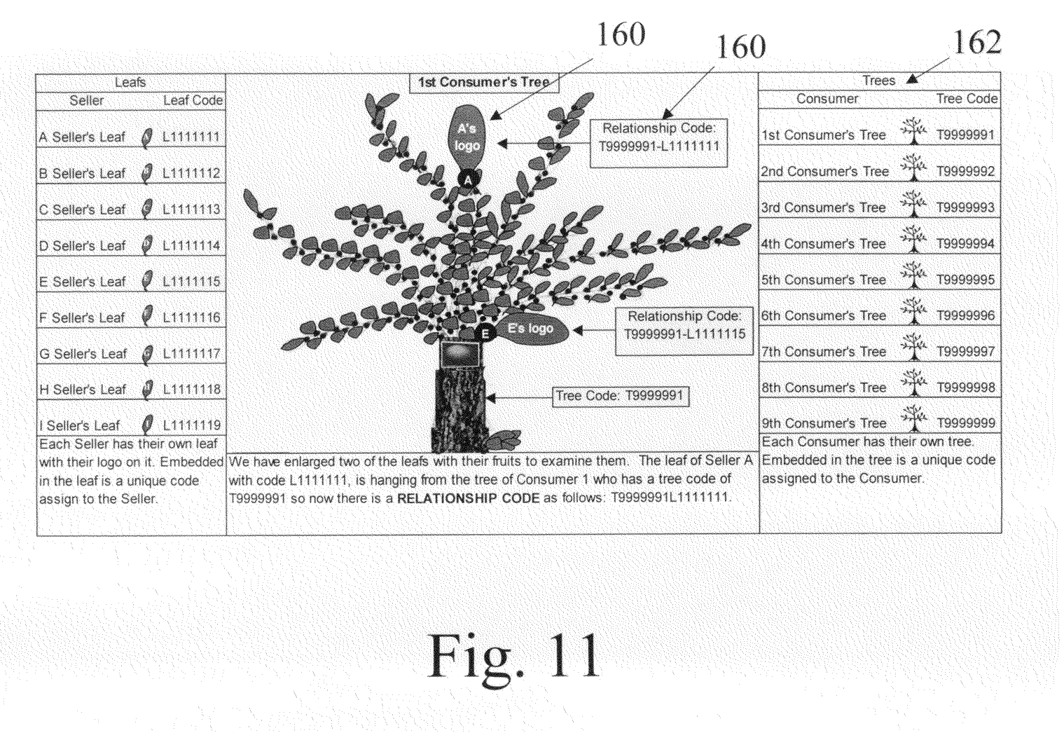

Each new leaf 1d the owner of the tree 1 acquires awaits under the tree Ito be hung in the desired place by the tree owner. Each branch or cluster 1a can be named as owner of tree wishes. By default, they are numbered. A Leaf 1b holds all commercial relationships, contact info, catalogues, links and any relevant to the specific Seller information. When a Leaf is placed on a Tree then a relationship is formed between the Seller (Leaf owner) and the Consumer (Tree owner) and a relationship code is generated by the System as shown in FIGS. 6 and 11 indicating that a solicited communication channel is opened up between the Seller and the Consumer for as long as the leaf remains on the Tree. Rewards can now be collected by the Consumer and Feedback is sent to the Seller by the Tree.

A Tree 1 is an organizer as well as a communications tool. This tree 1 is dedicated to commercial updates and the controls, communication channels, tools and gadgets that escort it as needed for that purpose. The same tree can be used by the Consumer in a different way (not for Commercial Relationships but to offer a few examples, a Tree can be used for Social Relationships or another Tree might be dedicated exclusively to Professional Relationships or the Consumer's Church group, or gym buddies, etc.). In this case the tree 1 will be escorted by a different set of controls 6, communication channels, tools 7, and gadgets 8 as are needed for the different purpose.

A Consumer can have as many trees 1 as needed and each tree opens in a different tab. The consumer can name the tab, and tools 7 are suggested (if available) accordingly. The Consumer can select which tools 7, gadgets 8, etc. to use and keep only those selected on the page.

Fruit holds relationship history that includes things like: messages, receipts, reward points earned, etc. Each leaf 1b is a feed (parameters of what, when and how often to bring messages are set by the tree owner). A Tree 1 can be turned to lists by clicking one of the controls 7. Branches 1b can be added to a Tree 1 as desired. Each Branch la can be isolated and enlarged by clicking on it, for better viewing. A Leaf 1b can be organized any way owner of tree desires. The leafs 1b are placed on the tree by the owner who can drag and drop in the desired place. They can be moved at any time in the same manner. A Tree 1 or Branch 1a can be asked to drop all leafs if re-organization is desired.

Each new leaf 1b the owner of the tree acquires awaits under the tree 1 to be hung in the desired place by the tree owner. Each leaf 1b represents a brand and each tree 1 represents a consumer. A leaf 1b represents a commercial entity (a Seller), and its logo is embedded on the leaf, and does not represent a relationship until it is hung on the Tree 1. Once the leaf 1b is hung on the Tree 1, a relationship code 1b is generated.

Prior to this invention a consumer could use their email address to register for a commercial mailing while this invention enables a consumer to register and not divulge their email and gain a lot more benefits like: control of what type of mailings they want to receive from each merchant and how often and rewards for every message they read and give feedback to.

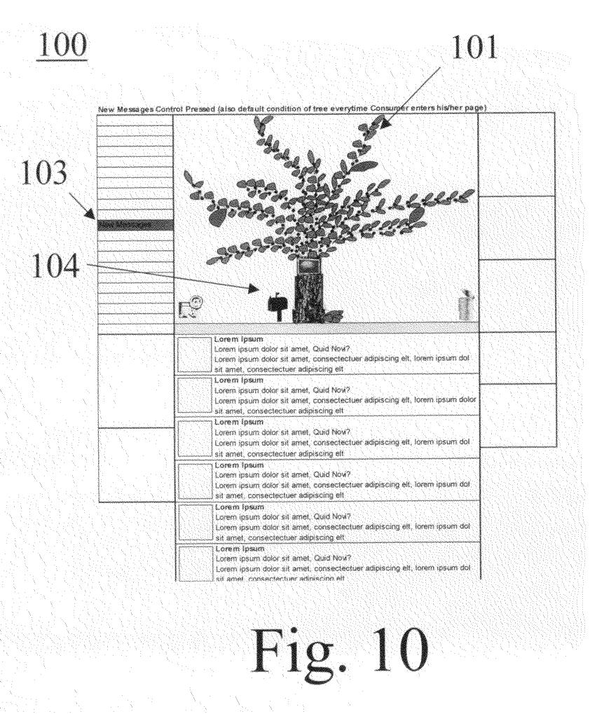

As shown in FIG. 10 each Commercial Tree 100 comes with 3 communication channels: Tree 101, Box 102, and Dedicated email INBOX 103.

The Tree 100 is for solicited commercial messages. So when a consumer subscribes to a list this is where the messages will be received. Each leaf of the tree represents a company that the consumer has chosen to communicate with. The leaf is a feed that the consumer sets parameters as to what type of messages and how often to receive them from each seller. Sellers can opt to reward consumers for each message read with commercial communication reward points that can be redeemed against future purchases.

The Box 102 is where unsolicited mail is received. This is a brokered communication channel exclusively dedicated to unsolicited commercial communication. Sellers interested to form a relationship with a consumer can send invitations here and ask for their leaf to be placed on the consumer's Tree. Each mailing sent here pays the consumer that reads it and sends feedback with cash.

The Dedicated email INBOX 103 is where consumers can receive messages from merchants they have subscribed to, that are not using the present invention yet. So when consumers are asked to subscribe to the mailing list of a merchant, that does not give them the option to do it through the present invention, the consumer gives this dedicated email and they still get the emails from this merchant in their page. The system allows even these non-participating merchant lists to be turned to leafs. However these leafs have a single information channel and offer no rewards. This way, consumers can collect all their commercial communication on one page and unclutter their life and not be interrupted when doing something else and also keep everything organized and easy to find.

Within the present invention there is an innovative loyalty program where consumers are rewarded not for shopping but for maintaining a two-way commercial communication channel with merchants. The rewards for unsolicited messages are cash and for solicited messages are points that can be redeemed on future purchases from each merchant.

An exchange or swap rings program allows each merchant to choose other merchants and form a ‘ring’ and permit consumers to use the rewards they have collected from one merchant with any of the other merchants of the ring as long as the participating merchants are on the consumer's tree.

A Network Rings Program allows complementary merchants to form a ‘ring’ and permit consumers to consumers to use the rewards they have collected from one merchant with any of the other merchants of the ring without requiring the participating merchants leafs to be on the consumer's tree. An example of such a ring would be a network of clubs, who in essence are competitors but due to their location they act as network merchants. (i.e. a club in Tampa and a club in N.Y. are complementary when a Tampa member is traveling for a week to N.Y.)

A Conversion Rings program allows rewards earned from other programs to be converted to commercial communication loyalty points and be redeemed for purchases from the merchants participating in a Conversion ring. The merchants participating in the Conversion Ring are gaining communication access to these consumers i.e. their leafs are added to the consumer's tree. Redemption continues as long as each leaf is on the consumer's tree and is active.

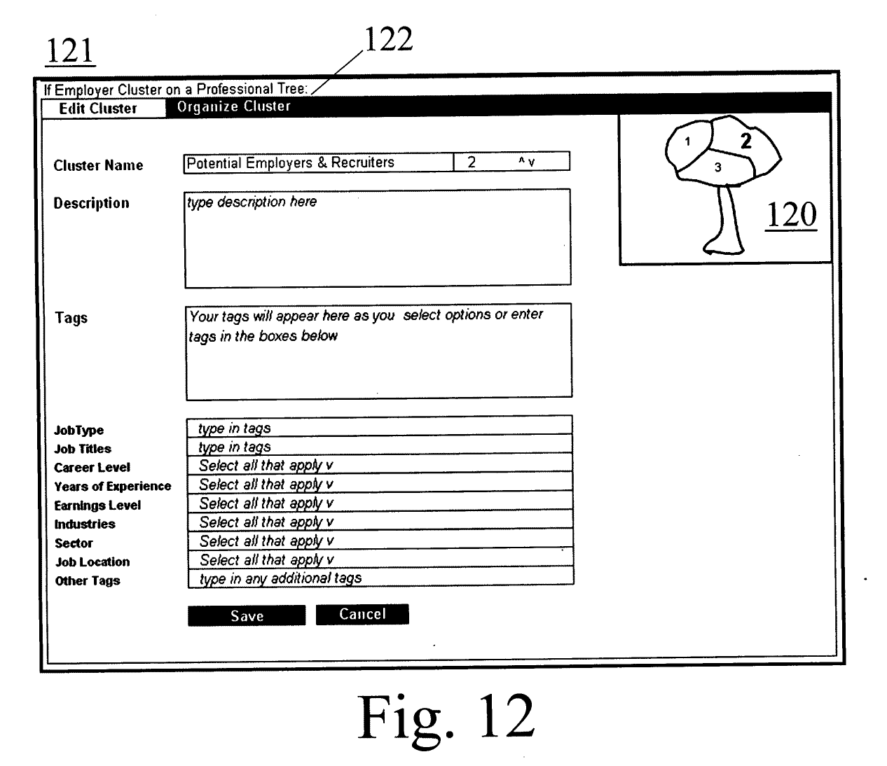

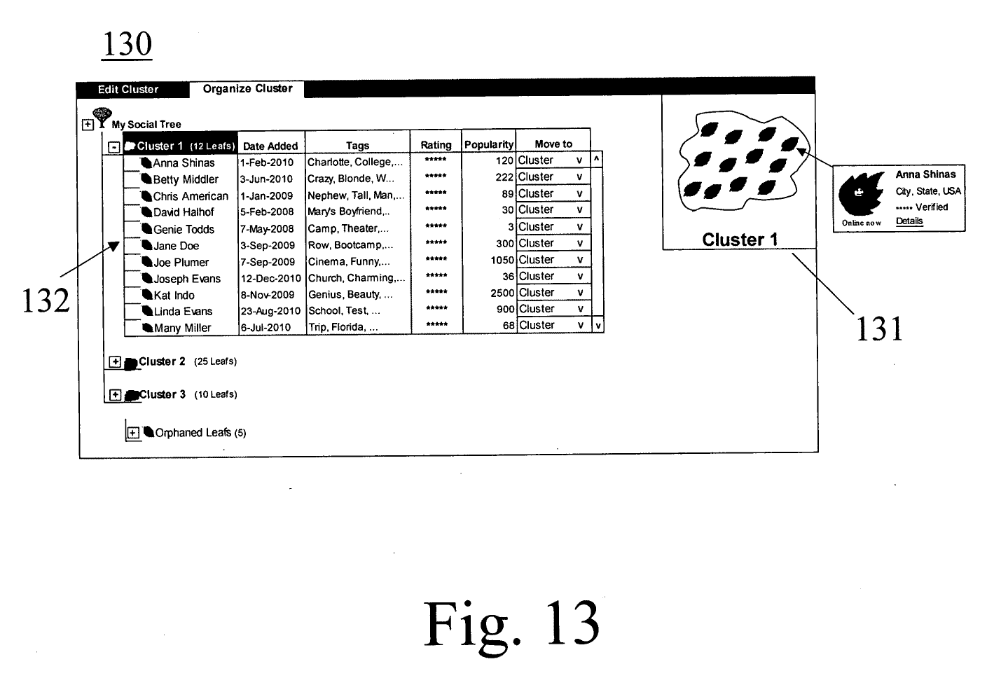

To create a tree, the software provides a wizard to provide a user with a step by step process. First a tree type is selected and a user can browse tree families or individual tree avatars and select the tree type you prefer. Next a background is selected and a user can browse different background options and select the background you prefer. A user can also choose whether they want their selected background to: follow time of day changes; follow local weather changes; follow both time of day changes and local weather changes; or remain unchanged. The next option is for a user to select tree clusters or branches. If ‘Select Sample Cluster Template and personalize it’ is chosen, then the user will: Select Sample Cluster Template; Personalize it by making any of these changes, if desired; Add cluster(s); Delete cluster(s); Edit cluster: Name, Position, Cluster Description, only if Tagged Cluster, Cluster Tags, only if Tagged Cluster, and finally save their Tree. If ‘Select a numbered Cluster Template’ is chosen: Select number of clusters; Name clusters; Edit cluster position if desired; Cluster Description, only if Tagged Cluster; Add Cluster Tags, only if Tagged Cluster; and Save the Tree. Once a tree has been saved a user can create any other trees they want or begin adding leafs to their tree. Users can edit their tree by selecting the tree Avatar 120 as shown in FIG. 12 and use the input screen 121 to make any changes to the cluster as desired. Additionally, a user can select the organize cluster tab 122 and use the input screen 130 show in FIG. 13 to organize the clusters 131 and individual leafs 132 that make up each cluster 131.

Trees can have one to an infinite number of clusters. Trees with 1-14 Clusters are displayed in one two-dimensional tree view. Trees with 15-28 Clusters turn once to display any clusters over 15, so this tree is comprised of two two-dimensional views. Trees with 29 or more Clusters turn more times. Each view holds a maximum of 14 Clusters.

To add leaves a user search/browses page where leafs can be found based on various keywords and criteria. When a desired leaf is found, user can click on the + sign on the leaf to add it on his/her commercial tree. This is the procedure for all business leafs whether B2C, B2B or Employer leafs and for Celebrity and Consumer leafs. In case of a person's Social leaf and a person's Professional leaf: When a “+” sign on leaf is clicked, pop up window opens allowing user to write a message that will escort the invitation sent to the leaf owner. A Leaf owner will receive invitation along with a link enabling him/her to see user's profile Leaf in the interim is kept under Pending Invites file of user's tree. A Leaf owner can: Accept invitation, in this case leafs are exchanged by the system automatically and placed under both users' trees awaiting organization by the respective tree owners. Also a notification is sent by the system to the user to let him/her know that invitation was accepted. A user can also Ignore an invitation without answering it. In this case leaf is erased from Pending Invites file of user's tree after 10 days. A user can Save an invitation to Review Later. In this case leaf remains in Pending Invites file of user's tree until manually erased; and in Invitations Review file of leaf owner until manually erased. A user can rejected and block another user. In this case leaf is erased from Pending Invites file of user's tree after 10 days and the User's name is placed in Blocked List of Leaf Owner's Tree; Another invitation cannot be sent again unless the block is removed by the Leaf Owner

A user can drop leafs, leafs fall under tree and tree owner can drag and drop to re-organize. Drop Leafs is a Treewide action or a cluster by cluster action.

A user can personalize their three by selecting: Tree name, Tree Avatar, Background, Number of Clusters, Cluster Names, and Cluster Positions. User can share their trees and this will send only Tree Clusters & Settings to a friend via email, it will not send contacts (leafs).

There are 2 types of clusters (or branches): Basic and Tagged. A tree can have only Basic or only Tagged or a mix of Basic and Tagged Clusters depending on its use. Clusters in combination with leafs enable tree to function as a relationship management system. Basic clusters are only used for organizational purposes. They function as user defined sub-lists of leafs. Tagged clusters are ‘smart’. The user defines them by adding description and tags (descriptive keywords). These clusters are used for organizational purposes, just like Basic clusters. In addition, these clusters have attraction capabilities. This means that the system recommends relevant leafs to attach to each cluster, that are ‘attracted’ by the cluster's tags. Tree owner has the option to keep or discard recommended leafs. Furthermore, these clusters serve as a user-defined site taxonomy. To explain this, let's look at the following example: A commercial network's site-defined taxonomy is: Standard Taxonomy of Businesses & Brands: Auto & Motors, Beauty & Fitness, Career & Business, Computers & Gadgets, Empowerment & Essentials, Fashion & Style, House & Home, Household & Everyday, Kids & Family, Leisure & Hobbies, Restaurants & Nightlife, Special Events & Holidays, Travel & Trips, Shopping & More.

When a tree owner (site user) has clustered his/her tree and created tags, the site can also be browsed by the user defined taxonomy shown in Table 1. This is accomplished as follows. When businesses sign up they select relevant categories and tags to be listed under. When a user wants to browse businesses using his/her personal taxonomy, the cluster defined categories pull together all the businesses whose listing tags match the cluster tags. All other businesses are listed under the category ‘Everything Else’.

TABLE 1

| Select Taxonomy | Select Taxonomy | Select Taxonomy |
|---|---|---|
| Standard (i.e. Site-defined) | >Standard | Standard |

| | | |
|---|---|---|
| Natasha's (i.e. User-defined) | All | >Natasha's |

| | |
|---|---|
| Auto & Motors | All |
| Beauty & Fitness | House |
| Career & Business | Personal |
| Computers & Gadgets | Panos |
| Empowerment & Essentials | Dimi |
| Fashion & Style | Business |
| House & Home | Entertainment |
| Household & Everyday | Travel |
| Kids & Family | Everything Else . . . * |
| Leisure & Hobbies | |
| Restaurants & Nightlife | |
| Special Events & Holidays | |
| Travel & Trips | |
| Shopping & More . . . | |

Natasha's

The matrix below in Table 2 shows some types of leafs. Leafs are categorized by owner (Personal, Celebrity, B2C businesses and brands, B2B businesses and providers, Employers) and by Tree they attach to (Social, Professional, Commercial). The matrix can be expanded with many more leafs following the same logic.

TABLE 2

| LEAFS | PERSONAL | CELEBRITY | B2C | B2B | EMPLOYER |
|---|---|---|---|---|---|
| SOCIAL | Social | Celebrity | | | |
| PROFESSIONAL | Professional | | | B2BLeaf | JobsLeaf |
| COMMERCIAL | Consumer | | AdLeaf | | |

A Leaf 160 is coded 161 to know which tree 162 it can attach to as shown in FIG. 11A Personal leaf for social use can only be used by Personal account holders For Social Networking. Settings of a leaf include: Reception, Access and Visibility. Reception settings enable a user to select which information channels they want to subscribe to and receive updates from and how often they want this leaf to pick up available updates. Access settings enable a user to also select all the access rights they want their friend (leaf owner) to have when visiting their profile and the type of stories and content their friend can see or will receive about them. (Stories are never visible to this friend about people that are invisible to him/her).

Visibility settings enable a user to also control who can see and can be seen by this friend. All leafs and clusters on Social Tree are shown and visibility selection can be made per leaf. When a user blocks people on his/her tree from seeing each other, then automatically the system does not let them see each other's leaf on user's tree, or any other interaction with user. For all intensive purposes, they are invisible to each other through user's tree. However, they may still meet each other in other areas of the web site.

A Personal leaf for consumers can only be used by Personal account holders for Commercial Networking. A Personal leaf for professionals (if freelancer, then use B2B leaf) can only be used by Personal account holders for Professional Networking All leafs and clusters on Professional Tree are shown and visibility selection can be made per leaf.

A celebrity leaf for celebrities can only be used by personal account holders who are celebrities for social networking; an ad leaf for B2C businesses and brands can only be used by business account holders for commercial networking; a B2B leaf for B2B businesses and freelancers can only be used by business account holders for professional networking; and a jobs leaf for employers and recruiters can only be used by professional account holders for professional networking.

When delete is selected pop-up window requests verification & if granted, leaf is deleted. When leaf is deleted, reciprocal leaf on other person's tree is automatically erased also. A new leaf can be added in several ways. To Manually Add Contact and Invite a user must Add Info manually (at minimum name and email required) then Click Invite and attach a personalized message instead of standardized message if desired. A Query is run and if contact is not a site member then the System will send email invitation to the email address provided. If site member then in-site invitation is sent. A Leaf is in Invitations Pending folder until invitation is accepted (not on tree). The User provides email and password and system automatically uploads all contacts, a query is run and contacts that are site members are shown and user has the options to select who to invite and attach personalized message. Contacts that are not site members are also shown and user has the options to select who to invite via email, and attach personalized message

For a user to find a leaf, a merchant has to be registered with site as Business User. A stage is created for each registered merchant along with merchant's leaf and listing. Users can find the merchant's leaf on the Search and Browse results, at a merchant's website or store, and on other people's commercial trees. A leaf can also be sent by a merchant, in a teaser ad, to the GreenBox of the User. Each leaf has a + sign on it and people can pick up a leaf by clicking on the + sign while they are logged in. Leaf is coded to know which tree it can attach to. If they are not logged in, then when they click on + sign, a message will be displayed asking them to log in to add the leaf on their tree. Other types of leafs work the same way.

To pick up a leaf inside the site, a search result will list all the Leafs that meet the search criteria and a User can click on the + sign on the leaf. If Registered Logged in User: a branch (or cluster) list will be displayed to select where user wants the leaf to go. Leaf is coded to know which tree it can attach to. So the list will display all the names of the user created branches (or clusters) of the tree it can attach to, along with the options ‘under the tree’ and ‘create a Branch _’ (by specifying a new Branch name). Once location is selected the user can click button ‘Leaf Settings’ or click button “Add Leaf” to finish and add settings later.

If ‘Leaf Settings’ is clicked then list of available merchant channels is displayed and user can select one, more or all and next to each channel user can select frequency per channel. The rewards per channel are also shown on the list (if LeafRewards is available through this Merchant). Leaf Visibility (visible or invisible) is also selected. Then Add Leaf button is clicked to finish. When Add Leaf is clicked success message is displayed: ‘Leaf has been added to user's commercial tree’. A User's consumer leaf is, at the same time, automatically added to merchant's tree (relationship established). A User can skip these steps by clicking Add Leaf button directly at any time and then leaf location and settings can be added when the user goes to his tree where the user will find leaf under the tree awaiting organization.

If a user is on the web and visits a participating merchant's website and sees their leaf and clicks on it to pick it up, the user will be asked to enter his user ID details on a window that opens in the system website and the process above will occur.

Once the user does this, steps above follow. If a user visits a store and sees a flyer that says ‘Sign up to the mailing list and receive points and great discounts’. The user is interested and picks up the flyer, the user can use SMS (Short Message Service) and install a mobile add-on on user's mobile OR register his mobile on his profile. Then all the user has to do is SMS the Leaf 1d to the specified number on the flyer (XXX). (A number given by the system to participating merchants for this purpose.). The information will be updated into the database with the help of Crawler. On logging in to the site, the User will find the leaf under his Tree. The User can then move it to the required Branch and add settings or delete it. A User's consumer leaf is, at the same time, automatically added to merchant's tree (relationship established).

Leafs that offer rewards have fruits on them (Business Leafs only). Fruits hold rewards statement and history. By single clicking a fruit, the user can see the current balance and expiry of his/her points. By double clicking the fruit, user is taken to rewards statement page and can see current statement and can go back to see previous statements from this business Reward statements (per business) include: dates and reward points collected, dates and reward points, redeemed, balance, and link to dispute an entry. By clicking on the Rewards tab on his tree page, a user is taken to a consolidated statement page where all the rewards programs from all the different businesses (merchants) is shown. Consolidated rewards statements (all businesses) include: Leaf (i.e. Business) name, Current Balance, Points Expiry, and Link to view full statement for each business.

Employers and Recruiters can also have leafs by registering with the site. Leaf can be displayed on site but also can be taken to employer site and displayed at careers section so that people visiting the site can register through the leaf to receive job updates on their professional tree. Steps include: employer creates jobs leaf, employer creates as many information channels as hiring job specialties; user's can add leaf on their professional tree; select job channels to receive updates from in this way subscribing to one or more of the employer's job channels; user can select blind subsciption or regular; if blind subcriber then employer cannot view name or other identifying info of user.

Businesses that have leafs can display them on site but also can take them to their websites and display them there as an alternative way for consumers to sign up to the business' mailing list without disclosing their email and in order to receive rewards. Businesses can also display leafs with all their flyers and in all their locations along with leaf ID and a specified SMS number (a unique ID and number given by the system to the merchants for this purpose)

Businesses that have leafs can choose to participate in Leaf Sense campaigns, by setting a budget. Web site owners pick up leafs and display them next to relevant content (contextually targeted leafs). If a leaf is clicked through to business specified url, then business has to Pay per Click (cheaper rate). If a leaf is added to a user's tree then business has to Pay per Leaf (higher rate).

Businesses that have leafs can choose to participate in Leaf Ranking campaigns (to rank high on search/browse results against targeted words), by setting a budget. If a Leaf is ranked in top three results on the web site, on top of organic results, for the keywords that the leaf owner has chosen to target. When budget runs out, the campaign ends. Pay per Click and Pay per Leaf rates apply here in the same way.

A Green Direct campaign targets consumers' Boxes by sending them Leaf Mail. It is an acceptable communication channel for unsolicited commercial communication. It is user friendly, non-intrusive, environmentally responsible and rewarding. The steps include: Set budget, Browse and select consumers to send teaser ad to, Prepare teaser and attach leaf, Set teaser expiration date (if teaser is opened after expiry date no monetary reward can be collected), Set offered rewards, Monetary and/or, Reward Points Boost for keeping leaf, and Place budgeted money in escrow. Money will remain in escrow until 5 days after teaser expiration date (so that all consumers who have opened the teaser can be paid their rewards). At the end of the 5 days, system gives business final accounting and releases any unspent balance. Unopened teasers remain in consumers GreenBox for a period of 10 days after expiry or until erased, whichever comes first. When consumer opens a teaser and provides the business with feedback, within expiry date, the consumer has two options: To collect monetary reward offered by business (even if leaf is not placed on tree) or To collect reward points boost offered instead (provided that leaf is placed on tree). When consumer opens a teaser after expiry date, monetary reward cannot be collected. Instead points boost can be collected. The qualifying action required by the user to receive the rewards is ‘feedback’ to the business within the expiry set on each teaser. When a teaser is sent by business, system allows business to monitor progress: Sent, Delivered (awaiting opening), Opened, Erased without opening, Leaf erased & Feedback, and Leaf placed on tree & Feedback

When teaser is opened, consumer sends feedback: + (positive impression); 0 (neutral impression); or − (negative impression). Adding a comment is optional with all these options. Consumers can set Box threshold as they wish. This allows them to exclude some businesses, some business categories, businesses with unacceptable reputation score and/or unacceptable reward levels. When threshold criteria are not met, the Box cannot be targeted by business.

Leaf Mail is displayed in primary marketplace while campaign runs, for any interested consumers that were not targeted by business but are interested. Consumers can browse and find and pick up leaf and collect points boost only. Leaf Mail is displayed in secondary marketplace for 15 days (if business desires) after the expiry of the campaign and consumers can find and pick up leaf collecting the points boost only.

An unprecedented loyalty program offers rewards for maintaining an open communication channel with a business (not for shopping) and rewards sending feedback to updates received. It allows each user to participate in a multitude of business lists without disclosing their email and earn rewards just for giving merchants communication access and feedback. Each user can EARN, TRACK, MANAGE, REDEEM, SWAP, EXCHANGE, CONVERT, BUY, SHARE and REFRESH leaf rewards from a multitude of businesses from one convenient place!

It offers businesses a way to maintain a mailing list that works and brings feedback and results while it enables each business to run their own communication rewards program by setting their own rewards parameters and changing them as they see fit. The program lets each business reward its list-members separately for their participation to their mailing list and motivates them not only to keep communication access to that business open but also to shop in order to use their earned rewards. Rewards are named points.

The system/platform can manage multiple commercial lists and Rewards Programs for Commercial Communication. Reward Programs are optional to participating businesses. The System is acting as Facilitator, System owner and Management Platform and bears no ownership of each merchant individual LeafRewards Program. Each merchant (leaf) owns their own LeafRewards Program and sets his own reward program parameters, points formulas, Merchant RT&C (merchant specific Rules, Terms and Conditions) and bears full responsibility towards members for all rewards granted by merchant to members. System has quality standards and sets the Core RT&C of the system and rewards program that must be respected at all times by merchant and users and if conflict were to exist they supersede Merchant RT&C. The System rewards mailing list participation. It rewards members for desired behaviors (like place merchant leaf on member tree, read message & send feedback, etc.), and penalizes undesirable behavior (like member drops leaf and loses all leaf points). It also rewards referrals. The qualifying action required by the member to receive the rewards is ‘feedback’ to the merchant's list within the expiry set on each message. ‘Feedback’ is the same as explained above under Box.

LeafRewards is a lightweight XML format designed for sharing commercial headlines and other commercial web content organized by content channels while offering participants rewards. It is a method to distribute links to commercial messages or content in a users web site or stage that you'd like consumers to see. In other words, it's a mechanism to “syndicate” a user's commercials and “reward” a user's subscribers for reading them and sending feedback.

When the Leaf file is updated, all the consumer trees that subscribe to the leaf will be automatically updated. Feedback will be sent back to business and rewards will be distributed accordingly to the consumers. An RSS feed sends information from a site to a user. A leaf is totally controlled by the user and picks up information from the merchant per user's parameters, organizes the info on the consumer's tree and allows the user to collect rewards for every message red with feedback before it expires.

A business sets up a Leaf Rewards Program by: becoming a member of the site; then opt in rewards program; Set up accrual program parameters: Select list channels; Set reward points offered per channel per update; Set geographical area where consumer must reside to be eligible to participate in rewards program; Set boost points offered when leaf is picked up for the first time (whether through browsing or referral or any other way of discovering the leaf on the site or outside the site); set expiry date for rewards collected (cannot be less than 6 months and cannot be longer than the currently maximum set by system's Core RT&C). In case a user drops the business' leaf from tree, rewards expire immediately regardless of their original expiration date. Set Merchant RT&C

Set up redemption program parameters include where reward points collected can be redeemed against future purchases from the merchant by paying in combination with reward points and money. Where redemption is accepted by merchant (stores, merchant web site, etc.) Establish maximum spend thresholds (for example: rewards cannot exceed 50% of the value of an eligible product or service).

From the site, through a shopping gateway, a user clicks on a merchant's link and window opens to merchant shop on merchant site and the user can shop this way and redeem reward points as below. Going directly to the merchant site, when shopping (if user has downloaded add-on) when paying and checking out add-on will let user know if available rewards exist and can be used against part of the payment for the selected products. Add on automatically fills out leaf discount field and user can accept by giving PIN. If add-on is not downloaded, during checkout the leaf on merchant site next to discount field can be clicked and by logging in (username, PIN) rewards if available will be inputted in the field and the balance in dollars reduced accordingly. If payment is concluded the system is updated by deducting the points used accordingly from user and business' account.

A User can use the Card issued to him by System that works for all Leaf Rewards programs user participates in. Swipe card or show card and get approval through the site. This will also update the information into the system's Database, the user's and business' reward accounts

If merchant does not have computer, a Machine is installed at the Merchant shop (like credit card swipe machines). Swipe card in the Machine and get approval through the site. This will also update the information into the system's Database, the user's and business' reward accounts

A Merchant can put up products for points and money on system run e-shop. To do this, the system has an e-shop, with all the payment functionalities (shopping cart, credit card payment system, etc.) where merchants can list products. User can select the option, Redeem against Service, and Redeem against Product. Users will be provided with an interface where in the user can select from the list of Items against which the user can redeem points. On selection of items and specifying item, quantity, the points and money that are required to get the item or services will be displayed. The System will check for whether user has sufficient points to redeem against the items. On confirmation by the user after selecting all the items required. The points will be deducted from the available Redeemable points. And the money will be collected through credit card or Paypal system. A notification is send to the Merchant whose item is displayed for Redemption stating the userid who has redeemed the points against these products. The money is directly sent to the Merchant by credit card or Paypal. The Merchant will send the product to the User at his Mailing Address. The User can monitor shipping via a link provided by the merchant.

Leaf Rewards Privileges include: replenish, refresh, share, swap, exchange, convert and refer. Replenish allows a user to buy points directly from the merchant. A user can refresh after a qualifying action (determined by merchant) to extend expiry date of earned rewards. By sharing, every time someone sees a leaf on a users tree and clicks + (adds the leaf on their tree) you get reward points. A user can redeem rewards with another leaf on a users tree that participates in the same SWAP ring. A user can exchange the leaf points they have for the leaf points they want, with other members. The convert option awards from other rewards programs to leaf points and uses them with CONVERSION Ring Participating Merchants whose leafs are on a users tree. Refer a users leaf allows a user to a friend and collect rewards if the user places it on his/her tree.

Box rewards are part of the communication rewards program. Leafs/Trees are tools for solicited commercial communication with rewards in points and Box is a tool for direct marketing, unsolicited communication with cash rewards and points boost. Businesses that offer rewards can initiate or participate in existing Reward Rings. Reward Ring founders set merchant participation parameters: Approval needed (can join after application is approved—acceptance criteria set by ring); Open (any merchant can join—no application needed); and by invitation only (merchant must be invited to apply).

There are the following types of Reward Rings: Swap or Exchange Rings where Reward Points can be redeemed with other ring merchants provided communication access is granted by member (i.e. ring merchant leaf is on user's tree); Network Rings where Reward Points can be redeemed with other ring merchants without providing communication access. Example of such a ring would be a network of clubs, who in essence are competitors but due to their location they act as network merchants. (i.e. a club in Tampa and a club in N.Y. are complementary when a Tampa member is traveling for a week to N.Y.)

Conversion Rings allow Rewards collected from other programs can be converted and redeemed with other ring merchants provided communication access is granted by member (i.e. ring merchant leaf is on user's tree). Conversion rings can choose to accept one or all conversion methods: from other rewards to communication rewards, or backwards from communication rewards to other rewards, or both.

In an alternative embodiment, the trees may be sponsored providing an alternative networking business model. On the tree trunk there is a dedicated communication channel (TV) for the user's sponsor. which the user can reposition in other places within his/her networking page; This channel is controlled by the sponsor who can market to the user. This allows users to network: Free of cost and Commercial-free. The sponsor pays so that users can network without having to put up with any junk/spam advertising intrusions. Members can enjoy their friends without having to tolerate commercials or pop ups or having to have ads in the middle of their updates and conversations with friends. The commercial tree enables users to create an acceptable pathway for businesses they choose to communicate directly with them and enjoy a new level of OWNERSHIP and FREEDOM.

Preferred Status with a users sponsor: Not only a users sponsor has no control over a users suite, but a user gets preferred member status with them. A user can select a users sponsor from the available sponsors. A user's preferred member status comes with exciting benefits. These benefits vary between sponsors and are constantly evolving. A user can see a user's current benefit, receive sponsor news and benefit changes at the sponsor channel of a users suite.

Each communication tree can function in combination with its elements, to separate conversations. The Commercial Tree with all its elements (Profile, Leafs, Communication Channels, Apps, and Relevant Programs) is exclusively dedicated to commercial conversations and facilitates all forms (solicited, unsolicited, in-site, on-the-web) of commercial interaction.

An anonymous consumer profile is submitted and kept updated by consumers. Merchants can target people based on these profiles. Merchants can communicate with consumers using one of the communication channels provided by the tree system and described below. Consumer willingly offer relevant commercial info to help businesses target him/her more effectively.

Merchants create commercial leafs so that consumers can find their leafs and add them to their tree if interested in receiving updates from this merchant. Merchants have the option to offer rewards for each message opened by consumer, provided that feedback is provided by the consumer. Rewards points can be used towards future purchases from merchant. Each consumer has their own tree where they can add leafs of merchants that they want to receive updates from. Leaf settings enable consumers to control leaf reception and frequency.

Under each tree there is a box that can be used by merchants to target consumers instead of sending wasteful and intrusive direct mail to their homes. GreenBox settings enable consumers to control box reception parameters. Merchants can browse consumer profiles and select whom to target. Each message sent to a consumer's GreenBox offers monetary rewards or the option instead of collecting the money to receive a Reward Point Boost if consumer decides to place leaf on his/her tree.

Dedicated email provides a solicited communication channel between consumers and non-participating merchants. Through dedicated system email a user can sign up to any non-participating merchants mailing list without disclosing their personal email. The List can be turned to a leaf that goes on user's tree. Updates are collected by the system, on a business-dedicated space, every time a merchant sends them. A User has added settings to his/her leaf (which has only one channel, since non-participating merchant). A User's leaf will only pick up updates according to user settings; regardless of how often list sends updates to the system. Rewards are not possible in this case, since non-participating merchant.

Registered Users will use the login box and give username and pin OR if user has downloaded the browser add-on these will be filled out automatically by clicking the add-on.

A branch (or cluster) list will be displayed to select where user wants the leaf to go. Leaf is coded to know which tree it can attach to. So the list will display all the names of the user created branches (or clusters) of the tree it can attach to, along with the options ‘under the tree’ and ‘create a Branch ______’ (by specifying a new Branch name). Once location is selected the user can click button ‘Leaf Settings’ or click button “Add Leaf” to finish and add settings later.

If ‘Leaf Settings’ is clicked then list of available merchant channels is displayed and user can select one, more or all and next to each channel user can select frequency per channel. The rewards per channel are also shown on the list (if LeafRewards is available through this Merchant). Leaf Visibility (visible or invisible) is also selected. Then Add Leaf button is clicked to finish.

When Add Leaf is clicked a success message is displayed: ‘Leaf has been added to a users commercial tree’; the User is redirected to merchant site. The User's consumer leaf is, at the same time, automatically added to merchant's tree (relationship established). The User can skip these steps by clicking Add Leaf button directly at any time and then leaf location and settings can be added when the user goes to his tree where the user will find leaf under the tree awaiting organization.

This turns any mailing list or Feed subscription to a leaf you can place on a users tree. The Steps include: User will not have to provide email info to the Business to whom they want to subscribe to their mailing list; User is a member (tree owner) and has downloaded the add on; When user finds a Subscribe box or an RSS subscription box; They click on the add on and; The add on checks with the database if any other user has subscribed to this list; and if yes then takes the user to finish; in the case of a subscribe box an auto-generated masked email address will be imported into the email address field of the box and in the case of an RSS a masked url will be imported into the RSS field. (These are site generated—not user—email and url, and they only accept incoming messages from specified domains.). The user can finish here or can go through the steps to ‘select branch’ and ‘leaf settings’ as described above and then finish. A success message is displayed and the leaf is added on the user's tree.

Merchant website sends updates to list channels on their business stage in the site. This can be done through a proprietary email so that merchant site ONLY can mail to their stage. So all merchant has to do is add this email to the list channel and every time a newsletter comes out this will go to his stage automatically and system will continue with the steps below to update the leafs. For every channel of the merchant list a separate address will be given to merchant. Merchant creates channels on his stage and emails are generated immediately if the user selects email. Now when the merchant is on his site the user can use this add on to input automatically the email address on the different list channels or the user can do it manually.

Alternatively the user can do it through a Leaf Syndicated Feed: a separate leaf feed will be given per channel and info is fed to stage from the merchant website through the feed. So all merchant has to do is connect one feed to each list channel and every time a new version comes out this will go to his stage automatically and system will continue with the steps below to update all the leafs.

For every channel of the merchant list a separate feed will be given to merchant. The Merchant creates channels on his stage and feeds are generated immediately if the user selects feeds. Now when the merchant is on his site the user can use this add on to input automatically the feeds on the different list channels or the user can do it manually. When this is done either through email or through Leaf Feed, the stage receives the updated info of all the channels and the leafs pick up list channel updates from the stage as described below.

When a leaf is picked up by a consumer (and added to consumer's tree) the tree of the business is updated with the consumer's leaf automatically. If consumer drops businesses leaf, automatically consumer's leaf is also dropped from business tree. A network is established between Merchant and User that is controlled by User Leaf Settings. Member's leaf collects information from merchant as per user leaf Settings as follows: Whenever a leaf is set to pick up an update, the system will run a query to find if update is available by business for the specific information channel. If update is available, leaf will collect it and make it available to user. Also user's consumer leafs run daily queries to pick up any available changes in consumer profiles.

The Social Tree with all its elements (Profile, Leafs, Communication Channels, Apps, and Relevant Programs) is exclusively dedicated to social conversations and facilitates all forms (solicited, unsolicited, in-site, on-the-web) of social interaction. Through the social Tree's Communication Channels it provides a solicited communication channel between friends; invites unsolicited communication; and provides a dedicated email for a solicited communication channel between non-member-friends and users.

The Professional Networking Elements of the Social Tree with all its elements (Profile, Leafs, Communication Channels, Apps, and Relevant Programs) is exclusively dedicated to social conversations and facilitates all forms (solicited, unsolicited, in-site, on-the-web) of social interaction.

The Professional Tree provides: Solicited communication channel between professionals, employers and Suppliers; Invites & Sphere Invites: Unsolicited communication channel between 1^{st}, 2^{nd} and 3^{rd} degree relationships; and a Dedicated email providing a solicited communication channel between non-member-professionals, B2B Businesses, Employers and users.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for facilitating two-way interactive communication with relationship management recorded on computer-readable medium and capable of execution by a computer, said method comprising the steps of:
providing a computer system running software to enable a relationship tree;
creating one or more trees;
opening each created tree in a different tab on the display of the computer system;
naming the individual tabs;
said trees have three levels;
said first level being the tree;
said second level being the branches or clusters; and
said third level being the leafs;
providing communication-receiving means to a computer system;
said communication receiving means:
provides a two-way communication channel
provides receipt of all communications
rewards feedback
provides means for receiving solicited and unsolicited communications via three delivery channels; and
organizes relationships and communications;
displaying leafs with messages as enlarged;
selecting a leaf,
displaying messages listed in chronological order by date received;
hovering over a leaf causes message details to appear;
providing a selectable box to view messages for Commercial Tree;
providing tree controls as needed for each tree appear on the first column;
providing tree applications to appear in the same column when an applications tab is clicked; and
selecting which tools, and gadgets to use and keep only those selected on the page.

2. The method of claim 1, wherein the relationship tree is dedicated to commercial updates and the controls, communication channels, tools and gadgets that escort it as needed for that purpose;

3. The method of claim 1, wherein a tree has clusters or branches that can be used interchangeably.

4. The method of claim 1, wherein the first level tree is either for social, commercial, or professional contacts and can be expanded to include any other user-defined variations.

5. The method of claim 4, wherein
a commercial tree is comprised of tagged clusters only;
a social tree is comprised of basic clusters only; and
a professional tree is comprised of basic and tagged clusters only.

6. The method of claim 1, further comprising the steps of:
exploring a tree by zooming in and out of levels;
viewing it as a visitor or as an owner;
turning it to Tree/Hybrid/Frame view;
measuring and displaying the popularity of the levels; and
converting a tree to a series of lists.

7. The method of claim 1, further comprising the step or providing fruit to the tree which is comprised of relationship history that includes: messages, receipts, and reward points earned.

8. The method of claim 5, wherein a commercial tree is comprised of three communication channels:
the Tree, a selectable box, and a dedicated email inbox;
the Tree is for solicited commercial messages;
each leaf of the tree represents a company that the consumer has chosen to communicate with;
the leaf is a user-controlled feed that the consumer sets parameters as to what type of messages and how often to receive them from each seller;
sellers can opt to reward consumers for each message read with commercial communication reward points that can be redeemed against future purchases;
the selectable box is where unsolicited mail is received;
sellers interested to form a relationship with a consumer can send invitations the selectable box and ask for their leaf to be placed on the consumer's Tree;
each mailing sent to the selectable box pays the consumer that reads it and sends feedback with cash;
the dedicated email inbox is where consumers receive messages from merchants they have subscribed to, but are not site-participating merchants and do not have their own trees.

9. The method of claim 5, further comprising the steps of:
providing a communication loyalty reward program;
rewards are offered by merchants not for shopping but for communication access and mailing list participation;
rewards for unsolicited messages are cash; and
rewards for solicited messages are points that can be redeemed for discounts on future purchases from each merchant
acting as a facilitator and having quality standards and providing rules, terms and conditions that supersede the merchants;
each merchant owning their own rewards program and setting their own reward program parameters, points formulas, spend thresholds, merchant rules, terms and conditions and bearing full responsibility towards users for all rewards granted by merchants to users;
reward system privileges that include: replenish, refresh, share, swap, exchange, convert and refer; and
reward rings include: swap or exchange rings, network rings and conversion rings that can be open, or require approval to join or by invitation only.

10. The method of claim 9, further comprising the steps of:
merchant created rings including the following types or rings;
providing an exchange or swap rings program that allows each merchant to choose other merchants and form a ‘ring’ and permit consumers to use the rewards they have collected from one merchant with any of the other merchants of the ring as long as the participating merchants are on the consumer's tree;
providing a conversion rings program that allows rewards earned from other programs to be converted to commercial communication loyalty points and be redeemed for purchases from the merchants participating in a conversion ring as long as each leaf is on the consumer's tree and is active or backwards, commercial communication loyalty points to be converted to other reward program points, or providing for conversion in both directions;
providing a network rings program that allows rewards to be redeemed with other ring merchants without requiring that the consumer grants communication access (i.e. participating merchants don't need to be on the consumer's tree; and
providing options to join: open, by invitation only or approval needed.

11. The method of claim 1, wherein
a tree can have only basic or only tagged clusters or branches individually or a mix of basic and tagged clusters depending on its use;
clusters in combination with leafs enable the tree to function as a relationship management system;
basic clusters are only used for organizational purposes; and
basic clusters function as user defined sub-lists of leafs.

12. The method of claim 11, wherein
tagged clusters are defined by adding description and tags (descriptive keywords) to identify the cluster;
tagged clusters are used for organizational purposes and have attraction capabilities; and
based on said tags, recommendations to relevant leafs to attach to each tag cluster are provided, that are ‘attracted’ by the cluster's tags; and
tagged clusters enable user-defined site organization and browsing.

13. The method of claim 1, wherein
a leaf is coded to know which tree it can attach to;
various types of leafs, are provided for different uses;
each leaf has visibility, access and reception settings that tree owner can customize when placing leaf on their tree;
a personal leaf for social use can only be used by personal account holders for social networking;
a personal leaf for consumers can only be used by personal account holders for commercial networking;
a personal leaf for professionals can only be used by personal account holders for professional networking;
a celebrity leaf for celebrities can only be used by personal account holders who are celebrities for social networking;
an ad leaf for B2C businesses and brands can only be used by business account holders for commercial networking;
a B2B leaf for B2B businesses and freelancers can only be used by business account holders for professional networking; and
a jobs leaf for employers and recruiters can only be used by professional account holders for professional networking; and
more leafs can be created in the same way for other types of users or networking purposes.

14. The method of claim 1, wherein businesses that have leafs can choose to participate in campaigns which provide rewards to third parties and advertising and marketing to the business:
providing businesses that have leafs can choose to participate in Leaf Sense campaigns where web site owners pick up leafs and display them next to relevant content contextually targeted leafs;
providing businesses that have leafs can choose to participate in Leaf Ranking campaigns to rank high on search/browse results against targeted words; and
providing businesses that have leafs can choose to participate in direct marketing campaigns to send unsolicited messages to consumers' selectable box.

15. The method of claim 9, further comprising the steps of:
providing each consumer their own tree where they can add leafs of merchants that they want to receive updates from;
providing under each tree a selectable box that can be used by merchants to target consumers;
allowing merchants to browse consumer profiles and select who to target;
requiring that each message sent to a consumer's selectable box offers monetary rewards or the option instead of collecting the money to receive a Reward Point Boost if consumer decides to place leaf on his/her tree; and
allowing users to set selectable box threshold as they wish in order to exclude some businesses, some business categories, businesses with unacceptable reputation score and/or unacceptable reward levels so that when threshold criteria are not met, the selectable box cannot be targeted by a business.

16. The method of claim 9, further comprising the steps of:
providing a syndicated feed if leaf is updated through merchant's website;
providing each merchant can create as many information channels as needed;
providing a separate leaf feed be given to the merchant per channel;
providing updates are fed from the merchant's website through these feeds;
providing that, if leaf is directly operated through merchant's stage on our website and not through merchants web site, updates are uploaded to each channel directly by merchant;
when a leaf is picked up by a consumer and added to consumer's tree the tree of the business is updated with the consumer's leaf automatically;
a network is established between merchant and user;
a user's leaf collects information from merchant per user defined leaf reception settings; and
a user's consumer leafs run daily queries to pick up any available changes in consumer profiles.

17. The method of claim 4, further comprising the steps of:
providing a social tree with communication channels that provides a solicited communication channel between friends; invites unsolicited communication; and provides a dedicated email for solicited communications between non-member-friends and users.

18. The method of claim 4, further comprising the steps of:
providing a solicited communication channel between professionals, employers and suppliers;
providing a solicited communication channel between 1^{st}, 2^{nd} and 3^{rd} degree relationships; and
providing a dedicated email providing a solicited communication channel between non-member-professionals, B2B Businesses, Employers and users.

19. The method of claim 1, further comprising the steps of the process of creating a tree;
selecting tree type where a user can browse tree families or individual tree avatars to select;
selecting a background where user can browse different background options to select;
by choosing whether selected background follows time of day changes; follows local weather changes; follow both time of day changes and local weather changes; or remains unchanged;
by selecting tree clusters or branches and personalizing them in one of two ways;
‘Select Sample Cluster Template and personalize it’ can be chosen, where the user will: Select Sample Cluster Template; Personalize it by making any of these changes, if desired: Add cluster(s); Delete cluster(s); Edit cluster: Name, Position, Cluster Description, only if Tagged Cluster, Cluster Tags, only if Tagged Cluster, and finally save their Tree;
‘Select a numbered Cluster Template’ can be chosen: where the user will Select number of clusters; Name clusters; Edit cluster position if desired; Cluster Description, only if Tagged Cluster; Add Cluster Tags, only if Tagged Cluster; and Save the Tree;
by creating any other trees user wants to use or begin adding leafs to their tree; and
by editing any of the user created trees by selecting the tree Avatar.

20. The method of claim 1, further comprising of:
tree owner customizing leaf when placing it on their tree by customizing leaf visibility settings (select who can see and can be seen by this leaf owner, making visibility selection per leaf. Stories are never visible to this leaf owner about leafs that are invisible to him/her);
by customizing leaf access settings by selecting all the access rights a user wants this leaf owner to have when visiting the user's profile and the type of stories and content this leaf owner can see or will receive about the user; and
by customizing reception settings by selecting which information channels the user wants to subscribe to and receive updates from and how often the user wants this leaf to pick up available updates.

21. The method of claim 1, further comprising the steps of how the leaf-feed picks up information instead of being fed information from lists:
when a leaf is picked up by a consumer and added to consumer's tree the tree of the business is updated with the consumer's leaf automatically;
a network is established between merchant and user;
user's leaf collects information from merchant per user defined leaf reception settings; and
user's consumer leafs run daily queries to pick up any available changes in consumer profiles.

22. The method of claim 1, further comprising of the steps of how leafs are added to a tree:
either by browsing and adding a leaf:
where user searches or browses leafs based on various keywords and criteria;
where in case of business leafs (B2C, B2B or Employer) and for Celebrity and Consumer leafs, user can click on the + sign on the leaf to add it on tree;
where in case of Social amd Professional personal leafs, user can click on the “+” sign on the leaf, add a message and if leaf owner accepoints invitation leafs are exchanged by the system automatically and placed under both users' trees awaiting organization by the respective tree owners;
where leaf is coded to know which tree it can attach to;
where said tree's branch (or cluster) list is displayed along with the options ‘under the tree’ and ‘create a Branch ______’ (by specifying a new Branch name). and user can select where leaf will go;
where user can continue by adding ‘Leaf Settings’ or click “Add Leaf” to finish and add settings later;
or by uploading leaf:
where user provides email and password and system automatically uploads all email contacts;
where a query is run and contacts that are site members are shown and can be invited within the site;
where contacts that are not site members are also shown and can be invited via email message.
or by manually adding a leaf:
where new leaf is created and info (at minimum name and email) is manually added;
where Click Invite;
where a query is run; and
where if contact is not a site member then email invitation is sent;
where if site member in-site invitation is sent; and
where a Leaf remains in Pending Invitations folder until accepted or erased.

23. The method of claim 1, further comprising of the steps of how a consumer can sign up to a mailing list without disclosing their email:
on the web with a participating merchant leaf owner by visiting merchant's website and clicking on the leaf to pick it up, entering his user ID details on a window that opens in the system website and then selecting where on tree he wants leaf to go, adding ‘Leaf Settings’ or clicking immediately “Add Leaf” to finish and add leaf position or settings later;
in a store by using SMS by having installed a mobile add-on on user's mobile OR having registered his mobile on his profile, then sending SMS with Leaf ID to the specified number by the store, a unique number given by the system to the merchants for this purpose, and on logging in to the tree later user will find the leaf under his Tree and can organize it, add settings or delete it;
on the web with non-participating merchants by user not have to provide email info to the Business to whom they want to subscribe to their mailing list; user is a member tree owner and has downloaded the browser add on; when user finds a Subscribe box or an RSS subscription box; user clicks on the add on and; the add on checks with the database if any other user has subscribed to this list; and if yes then takes the user to finish; in the case of a subscribe box an auto-generated masked email address will be imported into the email address field of the box and in the case of an RSS a masked url will be imported into the RSS field;
the user can finish here or can go through the steps to ‘select branch’ and ‘leaf settings’ and then finish; a success message is displayed and the List is turned to a leaf that goes on user's tree;
updates are collected by the system, on a business dedicated space, every time a merchant sends them; when a user adds settings to his/her leaf which has only one channel, since non-participating merchant;
the leaf will only pick up updates according to user settings, regardless of how often list sends updates to the system.

24. The method of claim 1, further comprising:
providing an alternative networking business model where trees are sponsored;
where there is a dedicated communication channel (TV) on the tree trunk for the user's sponsor;
where this channel is controlled by the sponsor and not tree owner;
providing that the user can reposition this TV in other places within his/her networking page;
providing that a user can select a user's sponsor from the available sponsors;
providing that the user's sponsor, in exchange for having this dedicated TV channel to market to the consumer, covers all costs so that the consumer can enjoy networking free of cost and commercial-free.
providing also for Preferred Member Status with a user's sponsor.
providing that preferred member status comes with exciting benefits that are defined individually by each sponsor, vary between sponsors and are evolving since they can be re-defined at any time by each sponsor.

25. The method of claim 17, further comprising of subscribing to an employer's list for job updates through the jobs leaf:
where a jobs leaf for employers and recruiters can only be used by professional account holders for professional networking;
employer registers;
employer creates jobs leaf,
employer creates as many information channels as hiring job specialties;
user's can add leaf on their professional tree; select job channels to receive updates from in this way subscribing to one or more of the employer's job channels; and
user can select blind subsciption or regular; if blind subcriber then employer cannot view name or other identifying info of user.
